(19) United States
(12) Patent Application Publication
(10) Pub. No.: US 2026/0195697 A1
(43) Pub. Date: Jul. 9, 2026

(54) SYSTEMS AND METHODS FOR BUILDING DYNAMIC INVENTORY DATA MODELS, INCLUDING INVENTORY DATA MODELS RELATED TO DISTRIBUTED COMPUTING PLATFORMS AND OPERATIONS OR SECURITY OF SUCH COMPUTING PLATFORMS

(71) Applicant: Zigguratum, Inc., Dover, DE (US)

(72) Inventors: Benjamin Eliot Newton, Borough Green (GB); George Davis Webster, III, Sevenoaks (GB); Aurelia Zoe Eva von Pentz, London (GB); Daniel Stewart, Coaltown of Balgonie (GB)

(21) Appl. No.: 19/443,625

(22) Filed: Jan. 8, 2026

Related U.S. Application Data
(60) Provisional application No. 63/743,494, filed on Jan. 9, 2025.

(51) Int. Cl. G06Q 10/067; G06Q 10/087

(52) U.S. Cl. CPC G06Q 10/067; G06Q 10/087

(57) ABSTRACT

Systems and methods for inventory data management are disclosed. Inventor data management systems adapted for dynamically generating data models or from a tiered, easily extensible data model definition are disclosed. Data modeled in this manner may be easily utilized in a variety of use cases or scenarios in an efficient and up to date manner by dynamically constructing only those portions of a data model that may be explicitly requested or implicitly signaled.

### RELATED APPLICATIONS

The present application claims the benefit of priority under 35 U.S.C. § 119 of U.S. Provisional Application No. 63/743,494 filed Jan. 9, 2025, entitled “SYSTEMS AND METHODS FOR BUILDING MULTI-MODAL DYNAMIC INVENTORIES, INCLUDING INVENTORIES RELATED TO DISTRIBUTED COMPUTER NETWORKS OR PLATFORMS RELATED TO OPERATIONS, SECURITY OR FINANCE,” which is hereby fully incorporated by reference herein.

### COPYRIGHT NOTICE

A portion of the disclosure of this patent document contains material to which a claim for copyright is made. The copyright owner has no objection to the facsimile reproduction by anyone of the patent document or the patent disclosure as it appears in the Patent and Trademark Office patent file or records but reserves all other copyright rights whatsoever.

### TECHNICAL FIELD

This disclosure relates generally to data management, including in the context of enterprise resources. In particular, embodiments of this disclosure relate to data models and their use for resource management in the context of operations of large scale enterprises. Even more specifically, embodiments of this disclosure relate to data models and their use for operations of large scale enterprises and the interconnection and overlap of areas of resource management such as resource management associated with cybersecurity, information technology (IT) operations, business operations or finance. More specifically, embodiment of this disclosure relates to data models and their uses in the areas of Security Posture Management (SPM), Configuration Management Databases (CMDB) and Enterprise Resource Planning (ERP).

### BACKGROUND

To elaborate on the problems discussed above, data ingestion and modeling is an epicenter of the myriad issues involved with managing large data sets. One of the main purposes of data modeling is to place the data in a form in which it can be meaningfully utilized. Conventional data modeling frameworks are typically predicated on the assumption that information from disparate data sources must be exhaustively transformed, mapped, and materialized as data objects in a predefined schema before meaningful interaction can occur. Thus, in typical systems incoming source data is conformed to data structures of a predefined data model definition to create data objects for a data model used to manage such data. The resulting repository of data objects (the data model) is therefore a static representation of the source information. As a result, data models obtained from such a process are static and inflexible.

Because such systems utilize a predefined data model definition, any modification requires disruptive reprocessing of the underlying source data. Moreover, when a new source system is added, its schema must be forcibly reconciled with the existing data model definition, even when such alignment is unnatural or semantically incongruent. Conversely, when the data model definition itself changes, all historical source data must be reinterpreted and the data model itself entirely recreated to reflect the revised structure of the new data model definition.

What is desired are more adaptive, efficient, and responsive systems and methods for determining, constructing and interacting with data models. Specifically, what is desired is the ability to ingest source data from multiple sources, model this data in a consistent manner using a straightforward and extensible data model definition, and analyze and present data using the data modeled in the manner.

### SUMMARY

To elaborate on the problems discussed above, data ingestion and modeling is an epicenter of the myriad issues involved with managing large data sets. One of the main purposes of data modeling is to place the data in a form in which it can be meaningfully utilized. The typical approach is to either place the data in structures for a data model that was determined a priori before ingestion of the data occurred. For example, data from data sources may be provided to a human data engineer who may take months to analyze the data and compose a structure (e.g., a schema or the like) in which ingested data can be placed. Not only is such a process time consuming, but additionally, the data engineer is operating from one particular view of the data at one particular time (e.g., a particular type of data or a particular version of data) and from a particular view or goal of how that data is to be utilized (e.g., a particular application that may utilize the data). Thus, the structure determined by this data engineer may be expressly tailored to that view of the data and those goals. Accordingly, the (materialized) data model obtained from such a process is static and therefore sclerotic. As this developed data model is tightly stitched to that particular type or version of data or how that data is to be utilized it is poorly suited to be adapted to other types of versions of data or to other goals.

To elaborate, conventional data modeling frameworks are typically predicated on the assumption that information from disparate data sources must be exhaustively transformed, mapped, and materialized as data objects in a predefined schema before meaningful interaction can occur. In prevailing systems, incoming source data is normalized and coerced into data structures conforming to the data model definition, after which corresponding data objects are created, stored, and maintained in accordance with the data model. The resulting repository of data objects (the data model) is therefore a static representation of the source information. Such artifacts therefore exist not based on any immediate demand or use case, but instead based on the theoretical possibility that some subset of the data objects may be queried, analyzed or otherwise utilized at some future time period. Although this paradigm has long served as the foundation of enterprise data modeling architectures, it introduces considerable rigidity and inefficiency, particularly as data volumes continue to expand and evolve at unprecedented rates.

A principal deficiency of this approach lies in its inherent requirement that virtually all available source data be processed upfront, regardless of whether any particular portion of that data will ultimately be accessed by a user. Because the model must be fully populated in advance, systems are compelled to ingest, transform, and persist massive quantities of information solely to maintain a complete instantiation of a data model for the source data. Such exhaustive materialization demands substantial computational resources, consumes significant storage capacity, and imposes high operational latency, especially when data source systems are characterized by rapid update frequencies, or large, continuously growing, datasets. As modern organizations increasingly rely on real-time and near-real-time data streams, these burdens become prohibitive, causing traditional data modeling techniques to falter under the weight of their own design assumptions.

Equally problematic is the structural inflexibility of these types of static data models. Because the data model definition is defined a priori, any modification (e.g., to incorporate a new class of data objects, to adapt to revised analytical requirements, to integrate an additional data source, etc.) requires disruptive reprocessing of the underlying source data (e.g., again demanding a large amount of computing resources). When a new source system is added, its schema must be forcibly reconciled with the existing data model definition, even when such alignment is unnatural or semantically incongruent. Conversely, when the data model definition itself changes, all historical source data must be reinterpreted and the data model itself entirely rematerialized to reflect the revised structure of the new data model definition. This wholesale reconstruction is not merely unduly consuming of additional computing resources and time; it can halt ongoing analytical operations, produce inconsistencies between old and new versions of a data model, and undermine an enterprise's ability to respond fluidly to evolving informational demands. The result is a brittle, sclerotic architecture—one that cannot readily accommodate new data types, shifting data requirements or uses, or emergent analytical paradigms.

These deficiencies are compounded by the extraordinary difficulty of versioning in conventional data modeling systems. To preserve a snapshot of the data model at any given moment in time, current methodologies typically require the entire model, every object, relationship, attribute, and structural component, to be fully persisted as a standalone instance. If it is desired that daily, hourly, or even more frequent snapshots, it is usually that a corresponding multiplicity of complete, fully materialized versions of the data model must be maintained. Each snapshot is essentially another full copy of a fully materialized data model, regardless of how little the underlying data may have changed. This situation leads to a proliferation of massive, sometimes redundant datasets, consuming enormous amounts of storage and vastly increasing the complexity of data management operations. Worse still, maintaining these versions imposes heavy burdens on backup operations, data retention policies, and compliance workflows, all of which must now account for the accumulating strata of full snapshots of a data model. The result is a resource nightmare—an architecture that becomes exponentially more unwieldy as the required granularity and frequency of versioning increase.

These limitations are further exacerbated by the explosive growth of data volume and variety in modern computing environments. Enterprises routinely ingest terabytes or petabytes of heterogeneous information originating from transactional databases, streaming sensors, collaborative platforms, machine-generated logs, and numerous other sources. Because traditional frameworks require full persistence of objects of a data model irrespective of their eventual utility, the operational cost escalates dramatically with data scale. Moreover, schema evolution challenges inherent in static modeling become particularly acute when source data is dynamic, episodic, or semi-structured, as is often the case with APIs, rapidly changing formats, or event-driven systems. Static data models are ill-equipped to adjust to such fluidity, creating persistent mismatches between the data model's assumptions and the realities of the underlying data.

Against this backdrop, it can be understood that there is a pressing need for more adaptive, efficient, and responsive mechanisms for constructing and interacting with data models. Specifically, what is desired is the ability to ingest source data from multiple sources, model this data in a consistent manner using a straightforward and extensible data model definition, and analyze and present data using the data modeled in the manner.

To address these needs, among others, embodiments as disclosed may be capable of dynamically generating data models or objects thereof from a tiered, easily extensible data model definition. Data modeled in this manner may be easily utilized in a variety of use cases or scenarios in an efficient and up to date manner by dynamically constructing only those portions of a data model that may be explicitly requested or implicitly signaled. Specifically, embodiments may store a data model definition for a semantic data model that comprises a set of layers adapted to illuminate data from a large number of (e.g., heterogeneous) data sources with a semantic context based on the semantic data model definition and to provide this contextualized data to various systems or applications that make use of that data. These data sources may comprise any source of data that can be identified with a point of origin such as network infrastructure devices, network management systems, software services, applications, logs, etc.

The (semantic) data model definition utilized by embodiments may be a multi-tiered semantic model, where each of the tiers (also referred to as layers) may comprise a set of concepts for (e.g., semantically) normalizing data. The tiers comprising the semantic model may be ordered based on the level of abstraction represented by each tier (e.g., from more specific to more general or abstract) such that the first (or bottom) tier of the semantic model may represent more (or the most) specific concepts for data normalization while the last (or top) tier of the semantic model may comprise the most general or abstract concepts for semantic normalization of data. As may be imagined there may be almost any number of intervening tiers between a first tier (e.g., the least abstract) and a (most abstract) tier of a data model definition. The first tier of such a semantic data model definition can include, for example, the definition of objects associated with specific data sources while a last tier of such a semantic data model definition may include a definition for objects representing how data may be consumed by an application or how data may be presented.

The data model definition can thus include a set of transformations that define how to generate data for concepts in a subsequent tier from one or more concepts in one or more (objects of) previous layers of the semantic model definition. These transformations can, for example, map one or more concepts (e.g. fields of various objects) included in a previous (e.g., less abstract) tier of the data model definition to one or more concepts (e.g., fields of various objects) in a subsequent (e.g., more abstract) tier in the data model definition. These transformations can include direct (e.g., one to one) mappings between concepts in the tiers or indirect mappings that define processing or manipulations to be performed on values for one or more concepts in one or more objects included in a previous (e.g., less abstract) tier of the data model definition to one or more concepts (e.g., fields of various objects) in a subsequent (e.g., more abstract) tier in the data model definition.

Thus, using a data model definition of this type a data model for use in a variety of contexts may be generated. Specifically, data sources may be defined (or provisioned) with respect to an inventory data system. These defined data sources can be associated with concepts in the first (least abstract) layer of the data model definition representing the specific type or configuration of that data source. Thus, in some embodiments, a materialized data model at the inventory data system may include data objects corresponding to the concepts of the first layer of the data model definition. As data is defined for, or received from, those sources this data may be stored at the inventory data system in the data store as the current data. When data objects for concepts in other higher layers of the data model are needed by the inventory data system, a working data model may be generated. When such higher tier concepts are determined (e.g., requested from, accessed at, etc.) by the inventory data system, a working data model comprising data objects for those higher tier concepts can be (e.g., at least temporarily) materialized (e.g., in a volatile memory).

It will be noted that because a working data model (and working data model definition) is generated dynamically from a current data model definition only when (e.g., certain determined) concepts in higher tiers of the data model definition are required, changes to the data model definition itself may generally be easily made without impacting the currently materialized data model and without the need to re-generate any materialized data model. Moreover, the concepts of the altered data model definition may be utilized substantially immediately by users or applications. As soon as the data model definition is altered, this new version of the data model will be utilized in generating working data model definitions and working data models, taking these any defined (or removed) concepts and transformations into account accordingly (e.g., without having to regenerate and materialized data model).

Additionally, the data structures and methodologies utilized by embodiments may be similarly utilized with respect to providing versions of the data model Specifically, it has traditionally been the case that to store a version of a data model from a moment in time (e.g., an archived data model) it was necessary to persist the data objects of that version of the data model. In contrast, to allow embodiments of an inventory data system as disclosed herein to provide a data model associated with a specific time, embodiments may store snapshots of data from various time periods. These snapshots are just the state of the current data as it may exist at some point in time. Additionally, data model definition snapshots may be stored for various points in time (e.g., any time the data model definition). Again, these data model definition snapshots may include data model concepts according to order tiers (also referred to as layers) and a set of transformations (e.g., between each of the tiers) that define how to generate data for concepts in a subsequent tier from one or more concepts in one or more (objects of) previous layers of the data model definition

Thus, when a user desires a data model for a particular time, a version of the data model corresponding to that time may be dynamically generated by obtaining a data model definition snapshot associated with a previous time closest to the particular time desired, obtaining the data snapshot associated with a previous time closest to the particular time desired and applying the transformations to dynamically generate the data for the particular desired time. Moreover, only those portions of the data model for the particular time may be generated if desired. For example, a user or application can be presented with the ability to select or specify particular (e.g., higher level) concepts available in the data model definition snapshot associated with the particular desired time. Once these selected or specified concepts are determined, only data objects for the data model associated with those selected or specified concepts (e.g., the specified or selected concepts along with any concepts necessary to generate those specified or selected concepts) need be dynamically generated to provide the selected or specified concepts for that particular desired time. These specified or selected concepts can, for example, be generated in a similar manner to a working data model, as described.

As such embodiments provide specific types of data structures (e.g., data model definitions including tiers of concepts and transformations that can be utilized to dynamically generate working data models or versions of a data model, including data objects for various tiers in a data model definition) designed to improve the way computing platforms, including inventory data system, store, generate or retrieve desired data. Accordingly, embodiments may dramatically reduce the computational and storage overhead associated with traditional approaches to generating and using data models. By avoiding the precomputation, persistence, and repeated versioning of data models, including unused or marginally relevant objects, embodiments may enable on-demand data interaction without requiring complete materialization of a data model. Embodiments may also obviate the need for storing redundant model snapshots by enabling reconstruction of temporal states without duplicating the entire model for each version. Collectively, these improvements mitigate many of the inefficiencies and structural limitations that encumber conventional data modeling, thereby enabling fluid, scalable, and context-sensitive interaction with complex, rapidly changing data ecosystems.

In one embodiment, a data modeling system may store raw data received from one or more data sources at a data management system, wherein raw data from the one or more data sources is received according to different data schemas. Such data sources may include, for example, an SPM system, a CMDB system or an ERP system. A requested concept defined in a semantic layer of a data model definition can be determined. Such a data model definition can include multiple layers of concepts, and transformations between each of the multiple layers of concepts. The multiple layers can include a first layer comprising a device layer and a second layer comprising the semantic layer, and the transformations can define a derivation for generation of data for concepts in a more abstract layer of the multiple layers from concepts in a less abstract layer of the data model definition. A semantic layer may include, for example, a foundation layer, an authoritative layer, a reporting semantic layer, a detection layer, or a presentation layer.

Accordingly, a working data model comprising first data objects for the requested concept can be generated in embodiments by determining second concepts of the first tier based on the requested concept by evaluating transformations of the data model definition associated with the requested concept, where the second concepts are associated with data sources providing data associated with the requested concept. The working data model can be, for example, dynamically generated in response to the determination of the requested concept. Second data objects associated with the second concepts can be obtained, where the second data objects are associated with raw data received from the data sources providing data associated with the requested concept. The second data objects can be, for example, obtained from a previously materialized data model.

These second data objects can be added to the working data model. Transformations of the data model definition associated with the requested concept can be applied to the second data objects associated with raw data received from the data sources to generate the first data objects associated with the requested concept, and the first data objects can be added to the working data model. This working data model, including the requested concept, can be provided for use by the data modeling system to, for example, be utilized by other components of the system, for use in responding to a request for data, or for other purposes.

Some embodiments may store a data model definition snapshot associated with a time and a data snapshot of raw data associated with the time. In response to a request, embodiments can thus generate a version of the data model associated with the time by applying the data model definition snapshot to the snapshot of raw data for the time. Such a request can specify a concept associated with the data model definition snapshot. In response to this type of request, the version of the data model definition may be generated such that it includes (e.g., only) data objects associated with that specified concept.

These, and other, aspects will be better appreciated and understood when considered in conjunction with the following description and the accompanying drawings. The following description, while indicating various embodiments and numerous specific details thereof, is given by way of illustration and not of limitation. Many substitutions, modifications, additions or rearrangements may be made within the scope of the disclosure, and the disclosure includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a block diagram of an embodiment of an inventory data system.

FIG. 2 is a block diagram of an embodiment of a network topology including an embodiment of an inventory data system

FIGS. 3A-3J are diagrams depicting various aspects of embodiments of a data model definition.

FIGS. 4A and 4B (collectively FIG. 4) is a diagram of one embodiment of a method for a utilization method.

FIGS. 5A and 5B (collectively FIG. 5) is a diagram of one embodiment of a method for a converged accuracy method.

FIG. 6 is a diagram of one embodiment of a method for creation and use of a data model definition.

FIGS. 7, 8A and 8B (collectively FIG. 8), 9, 10, 11, 12A-12B (collectively FIGS. 12) and 13 are depictions of embodiments of interfaces that may be utilized by an inventory data system.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Before delving into more detail regarding the specific embodiments disclosed herein, some context may be helpful. In the era of vast and complex datasets, inventory data systems are crucial for the efficient storage and processing of such large volumes of data, including the indexing of such data for search, analysis or use by other applications. Traditional data management systems and methods often struggle to keep pace with the ever-growing volume and intricacy of data and changing user requirements.

Specifically, in the past these data management problems have been addressed either by providing increasing amounts of money and compute capabilities for inventory data systems to employ map reduce or similar algorithms under a defined structure based on current use cases, or by indexing all the relevant data. This decision was left to either the discretion of the system builder or the system user. As data volumes are rising exponentially around the world, this solution is becoming unsustainable and resource scarcity is rising.

A microcosm of these problems occurs in the context of enterprise planning and resource management. To effectively manage your resources, there is a need to know what an enterprise includes. For example, to manage a risk, a user needs to know what is exposed (to risk). To manage budgeting and forecasting, a user needs to know what is currently being used. To optimize deployment, a user needs to know where things (e.g., devices or human resources) are.

To illustrate in more detail, the modern enterprise is comprised of a large number of devices used in the course of operations of the enterprise. This includes traditional information technology (IT) infrastructure such as laptops, server and network infrastructure, but can also include Internet of Things (IoT) micro-devices, wearables and other specific smart hardware (such as medical devices), as well as the applications running on the devices. This places a heavy burden on the teams charged with managing this estate: all of whom require an accurate and up to date inventory of all hardware or other entities or assets of an enterprise as well as the applications running on these assets (collectively referred to as inventory herein).

Specifically in the context of cybersecurity monitoring the security posture of all the devices requires live telemetry and updates as well as wider security context. In the context of operations, in order to maximize efficiency, utilization and location metrics are required as well as overall device counts and maintenance requirements. In the context of finance, forecasting of current and future budgets are dependent on accurate reporting of infrastructure details (e.g., regarding device deployment, cost, usage, etc. Internal recharging & tax strategies also require an understanding of the current utilization of devices.

Thus, current data models used by ERP (Enterprise Resource Planning) systems face several key challenges that affect their flexibility, scalability, performance, and ability to adapt to modern enterprises needs. Typical ERP or individual systems utilized in implementation of functionality in an enterprise often rely on rigid, predefined data models that are highly integrated but lack flexibility. These systems are designed around a set of specific entities, devices or processes, leading to data being stored in silos tied to specific functional areas.

Part and parcel, such data models struggle with integrating data from external or different sources, such as third-party applications, cloud services, and IoT devices. These issues limit the ability of enterprises to gain a comprehensive, real-time view of operations across all systems and can create data duplication, inconsistencies, visibility gaps, and reconciliation challenges.

Moreover, because such data models tend to be centralized and highly structured, they often don't allow for flexibility in terms of data quality controls or real-time updates. When different modules in the system have inconsistent data formats or conflicting rules, it can lead to data integrity, interoperability or analysis issues. This lack of flexibility results in errors, missed opportunities, and poor decision-making, as inaccurate or inconsistent data may be used in reporting, analysis, forecasting, accounting (e.g., billing), or otherwise.

To explain in more detail, most prior solutions to data management and usage if such data in these contexts are all domain specific, targeted at specific use cases and relying on smaller datasets. Traditional ERP systems rely primarily on batch processing and user input to collate enterprise data. They are reactive processes since they rely on input to an upstream system in order to make course corrections. ERP focuses on business processes and relies on abstract business concepts. These abstract concepts are ill suited to represent concrete entities and batch processing is ill suited for real-time processing, analysis and presentation of enterprise data.

A CMDB is designed for IT service management, often following Information Technology Infrastructure Library (ITIL) standards of assets, services etc. Since these CMDB systems are designed to track IT hardware, they focus on individual items and align these to IT processes. Whilst there are often connectors to data sources, less common device types are often not natively supported or dealt with effectively in these CMDB systems.

Security Posture tooling (‘SPM’) is designed to consume various cybersecurity data sources to report the overall security health of the business. This traditionally has a high frequency of update, but is specialized within its domain. Such tools are generally blind to assets not directly reporting which means it cannot accurately track gaps in posture. Furthermore, these tools are not aligned with an enterprise's (e.g., business) processes at all, and reconciliation using tagging or other reporting is required to align the security posture with the business lines.

Fundamentally, then all current tools are hyper-focused on solving a specific problem domain (finance/IT services/security) and therefore do not provide a truly holistic view of an enterprise and the enterprise's entities. Each tool has its own worldview, limitations and biases. Since there is no enterprise-wide strategic inventory solution, strategic decisions are made using tactical toolchains: which means those decisions inherit those biases and omissions. Existing solutions rarely deal with live data and are unable to deal with rapidly mutating state. It is also important to note here that large enterprises will have multiple instances of all these toolchains, further complicating their reporting structure.

What is desired then, and what embodiments as disclosed provide, is the ability to ingest source data from multiple sources, model this data in a consistent manner using a straightforward and extensible data model, and analyze and present data using the data modeled in a manner desired.

To elaborate, as data ingestion and modeling is an epicenter of the myriad issues involved with managing large data sets one of the main purposes of data modeling is to place the data in a form in which it can be meaningfully utilized. The typical approach is to either place the data in structures for a data model that was determined a priori before ingestion of the data occurred. For example, data from data sources may be provided to a human data engineer who may take months to analyze the data and compose a structure (e.g., a schema or the like) in which ingested data can be placed. Not only is such a process time consuming, but additionally, the data engineer is operating from one particular view of the data at one particular time (e.g., a particular type of data or a particular version of data) and from a particular view or goal of how that data is to be utilized (e.g., a particular application that may utilize the data). Thus, the structure determined by this data engineer may be expressly tailored to that view of the data and those goals. Accordingly, the (materialized) data model obtained from such a process is static and therefore sclerotic. As this developed data model is tightly stitched to that particular type or version of data or how that data is to be utilized it is poorly suited to be adapted to other types of versions of data or to other goals.

In the main this is because conventional data modeling frameworks are typically predicated on the assumption that information from disparate data sources must be exhaustively transformed, mapped, and materialized as data objects in a predefined schema before meaningful interaction can occur. In prevailing systems, incoming source data is normalized and coerced into data structures conforming to the data model definition, after which corresponding data objects are created, stored, and maintained in accordance with the data model. The resulting repository of data objects (the data model) is therefore a static representation of the source information. Such artifacts therefore exist not based on any immediate demand or use case, but instead based on the theoretical possibility that some subset of the data objects may be queried, analyzed or otherwise utilized at some future time period. Although this paradigm has long served as the foundation of enterprise data modeling architectures, it introduces considerable rigidity and inefficiency, particularly as data volumes continue to expand and evolve at unprecedented rates.

A principal deficiency of this approach lies in its inherent requirement that virtually all available source data be processed upfront, regardless of whether any particular portion of that data will ultimately be accessed by a user. Because the model must be fully populated in advance, systems are compelled to ingest, transform, and persist massive quantities of information solely to maintain a complete instantiation of a data model for the source data. Such exhaustive materialization demands substantial computational resources, consumes significant storage capacity, and imposes high operational latency, especially when data source systems are characterized by rapid update frequencies, or large, continuously growing, datasets. As modern organizations increasingly rely on real-time and near-real-time data streams, these burdens become prohibitive, causing traditional data modeling techniques to falter under the weight of their own design assumptions.

Equally problematic is the structural inflexibility of these types of static data models. Because the data model definition is defined a priori, any modification (e.g., to incorporate a new class of data objects, to adapt to revised analytical requirements, to integrate an additional data source, etc.) requires disruptive reprocessing of the underlying source data (e.g., again demanding a large amount of computing resources. When a new source system is added, its schema must be forcibly reconciled with the existing data model definition, even when such alignment is unnatural or semantically incongruent. Conversely, when the data model definition itself changes, all historical source data must be reinterpreted and the data model itself entirely rematerialized to reflect the revised structure of the new data model definition. This wholesale reconstruction is not merely unduly consuming of additional computing resources and time; it can halt ongoing analytical operations, produce inconsistencies between old and new versions of a data model, and undermine an enterprise's ability to respond fluidly to evolving informational demands. The result is a brittle, sclerotic architecture—one that cannot readily accommodate new data types, shifting data requirements or uses, or emergent analytical paradigms.

These deficiencies are compounded by the extraordinary difficulty of versioning in conventional data modeling systems. To preserve a snapshot of the data model at any given moment in time, current methodologies typically require the entire model, every object, relationship, attribute, and structural component, to be fully persisted as a standalone instance. If it is desired that daily, hourly, or even more frequent snapshots, it is usually that a corresponding multiplicity of complete, fully materialized versions of the data model must be maintained. Each snapshot is essentially another full copy of a fully materialized data model, regardless of how little the underlying data may have changed. This situation leads to a proliferation of massive, sometimes redundant datasets, consuming enormous amounts of storage and vastly increasing the complexity of data management operations. Worse still, maintaining these versions imposes heavy burdens on backup operations, data retention policies, and compliance workflows, all of which must now account for the accumulating strata of full snapshots of a data model. The result is a resource nightmare—an architecture that becomes exponentially more unwieldy as the required granularity and frequency of versioning increase.

These limitations are further exacerbated by the explosive growth of data volume and variety in modern computing environments. Enterprises routinely ingest terabytes or petabytes of heterogeneous information originating from transactional databases, streaming sensors, collaborative platforms, machine-generated logs, and numerous other sources. Because traditional frameworks require full persistence of objects of a data model irrespective of their eventual utility, the operational cost escalates dramatically with data scale. Moreover, schema evolution challenges inherent in static modeling become particularly acute when source data is dynamic, episodic, or semi-structured, as is often the case with APIs, rapidly changing formats, or event-driven systems. Static data models are ill-equipped to adjust to such fluidity, creating persistent mismatches between the data model's assumptions and the realities of the underlying data.

Against this backdrop, it can be understood that there is a pressing need for more adaptive, efficient, and responsive mechanisms for constructing and interacting with data models. Specifically, what is desired is the ability to ingest source data from multiple sources, model this data in a consistent manner using a straightforward and extensible data model definition, and analyze and present data using the data modeled in the manner.

To address these needs, among others, embodiments as disclosed may be capable of dynamically generating data models or objects thereof from a tiered, easily extensible data model definition. Data modeled in this manner may be easily utilized in a variety of use cases or scenarios in an efficient and up to date manner by dynamically constructing only those portions of a data model that may be explicitly requested or implicitly signaled. Specifically, embodiments may store a data model definition for a semantic data model that comprises a set of layers adapted to illuminate data from a large number of (e.g., heterogeneous) data sources with a semantic context based on the semantic data model definition and to provide this contextualized data to various systems or applications that make use of that data. These data sources may comprise any source of data that can be identified with a point of origin such as network infrastructure devices, network management systems, software services, applications, logs, etc.

The (semantic) data model definition utilized by embodiments may be a multi-tiered semantic model, where each of the tiers (also referred to as layers) may comprise a set of concepts for (e.g., semantically) normalizing data. The tiers comprising the semantic model may be ordered based on the level of abstraction represented by each tier (e.g., from more specific to more general or abstract) such that the first (or bottom) tier of the semantic model may represent more (or the most) specific concepts for data normalization while the last (or top) tier of the semantic model may comprise the most general or abstract concepts for semantic normalization of data. As may be imagined there may be almost any number of intervening tiers between a first tier (e.g., the least abstract) and a (most abstract) tier of a data model definition. The first tier of such a semantic data model definition can include, for example, the definition of objects associated with specific data sources while a last tier of such a semantic data model definition may include a definition for objects representing how data may be consumed by an application or how data may be presented.

The data model definition can thus include a set of transformations that define a derivation for how to generate data for concepts in a subsequent tier from one or more concepts in one or more (objects of) previous layers of the semantic model definition. These transformations can, for example, map one or more concepts (e.g. fields of various objects) included in a previous (e.g., less abstract) tier of the data model definition to one or more concepts (e.g., fields of various objects) in a subsequent (e.g., more abstract) tier in the data model definition. These transformations can include direct (e.g., one to one) mappings between concepts in the tiers or indirect mappings that define processing or manipulations to be performed on values for one or more concepts in one or more objects included in a previous (e.g., less abstract) tier of the data model definition to one or more concepts (e.g., fields of various objects) in a subsequent (e.g., more abstract) tier in the data model definition.

Direct mappings may, for example, indicate that the value for a concept of an object in a previous (e.g., less abstract) tier is to be used as a value for a concept of an associated object in a subsequent (e.g., more abstract) tier. Indirect mappings may define processing or manipulations to be performed on values for one or more concepts in one or more objects included in a previous (e.g., less abstract) tier of the data model definition to one or more concepts (e.g., fields of various objects) in a subsequent (e.g., more abstract) tier in the data model definition. Such indirect mappings may, for example, indicate that values for one or more concepts of one or more objects in a previous (e.g., less abstract) tier are to be used to determine a concept of an associated object in a subsequent (e.g., more abstract) tier and a transformation definition defining how the value for the concept in the associated object in the subsequent (e.g., more abstract) tier is to be determined. These transformation definitions may include rules on how to combine the values of the one or concepts of the one or more object to generate a value for a concept in the subsequent tier, how to select between the values of the concepts from the previous (less abstract) tier, data transformation to be performed on the values, or other rules for determining the value for the concept in an object in a subsequent (e.g., more abstract) tier of a data model from values from one or more concepts in data object of a previous (less abstract) tier.

Thus, using a data model definition of this type a data model for use in a variety of contexts may be generated. Specifically, data sources may be defined (or provisioned) with respect to an inventory data system. These defined data sources can be associated with concepts in the first (least abstract) layer of the data model definition representing the specific type or configuration of that data source. Thus, in some embodiments, a materialized data model at the inventory data system may include data objects corresponding to the concepts of the first layer of the data model definition.

As data is defined for, or received from, those sources this data may be stored at the inventory data system in the data store as the current data. This (raw) data can be stored in the format (e.g., schema) in which it is received from the individual data source or may be placed in an internal schema or representation). When data objects for concepts in other higher layers of the data model are needed by the inventory data system, a working data model may be generated. Specifically, desired or requested higher tier concepts (e.g., any concepts that may be defined in any tier of the data model definition that is higher than the first, least abstract, layer) may be specified by other components or subsystems of the inventory data system such as search subsystems or analytics platforms, or from other systems that interact with the inventory data system. For example, these higher tiered concepts may be determined based on user requested data (e.g., a search or specification of certain concepts defined in a higher tier of the data model definition) or may be requested or specified by analytics or other types of applications that may make use of such higher tier concepts.

When such higher tier concepts are determined (e.g., requested from, accessed at, etc.) by the inventory data system, a working data model comprising data objects for those higher tier concepts can be (e.g., at least temporarily) materialized (e.g., in a volatile memory). To generate such a working data model, initially a working data model definition may be determined. This working data model definition may include a set of working data model concepts and a set of working data model transformations. These working data model concepts can be the set of concepts in the data model definition that will be included in the working data model that may be used to provide the desired higher tier concepts. Thus, these working data model concepts can include the determined higher tier concepts and any concepts in any previous (less abstract) layers of the data model definition on which those higher tier concepts depend (e.g., that may be needed to generate those higher tier concepts), including concepts in the least abstract layer of the data model definition. Similarly, the working data model transformations may be the set of transformations that are to be applied between concepts of the working data model definition in one layer to generate concepts of the working data model in a higher layer (e.g., that may be needed to generate the determined higher tier concepts and any intervening concepts in different layers of the data model definition).

Thus, to determine working data model concepts and transformations, the transformations included in the data model definition may be evaluated based on the determined higher tier concepts to determine concepts of the first (lowest or least abstract) tier, and any intervening layers, of the data model definition that may be required to generate those higher tier concepts. These transformations and any determined concepts of the first tier and any intervening layers may be included in the working data model definition.

Initially, to determine the working model concepts the determined higher tier concepts may be added to the set of working model concepts. Each higher tier concept can then be evaluated to determine less abstract concepts in previous tiers of the data model definition on which that higher tier concept depends. The less abstract concepts for a higher tier concept can be determined by evaluating the transformations between the tier of the data model definition in which the higher tier concept resides and the previous tier (the previous or next least abstract layer) of the data model definition to determine the previous layer concepts (e.g., the concepts in the previous tier) mapped to that higher tier concept. These determined previous layer concepts and the corresponding transformations can then be added to the working data model concepts and transformations of the working data model definition.

If the previous layer is not the first (least abstract) layer of the data model definition, the concept and transformation determination process can then be performed recursively on each of the determined previous layer concepts until concepts in the first (least abstract) layer of the data model definition and their associated transformations are determined and added to the working data model concepts and transformations of the working data model definition. In other words, if the previous layer is not the first (least abstract) layer of the data model definition, each of the previous layer concepts can then be used as starting points to determine concepts in the next previous layer (less abstract) on which that previous layer concept depends and the associated transformations using the transformations between the previous layer and the next previous layer in the data model definition, and those next previous layer concepts and transformation added to the working data model concepts and transformations of the working data model definition, and so on until the concepts of the first (least abstract) layer on which the higher tier concepts depends and their associated transformations have been added to the working data model definition.

Once the working data model definition has been determined, to generate the working data model, the data objects of the currently materialized data model (e.g., the materialized data model stored at the inventory data system) corresponding to concepts of the first (least abstract) tier of the data model definition included in the working data model definition can be obtained from the materialized data model and added to the working data model. To determine the remainder of the working data model, the data (e.g., from the data sources) associated with these initial data objects added to the working data model (data objects associated with the first (least abstract) tier) can be used to generate data objects for each of the working data model concepts in each of the higher level tiers based on the source data associated with the initial data objects of the working data model. Specifically, the transformations included in the working data model definition can be applied to these initial data objects in the working data model to generate data objects for concepts in the next highest tier of the data model included in the working data model definition. This process of applying transformations of the working data model definition to the data objects of the working data model is continued until data objects for all the working data model concepts included in the working data model definition are generated and included in the working data model. This working data model can then be utilized to provide data (or data objects) for concepts in the determined higher layers of the data model that may be needed by the inventory data system (e.g., to perform analytics, provide a response to a request, return in response to a search, etc.).

It will be noted that while it may be desirable in some embodiments to create and materialize (and persist) a current data mode, the creation and persistence of such a current data model may not be necessary. In fact, all that may be required to generate a working data model and working data model definition may be a set of current data and a data model definition. While embodiments have been described as including a materialized data model (e.g., which may be stored in non-volatile memory or otherwise persisted in some manner) comprising data objects for concepts in the first (least abstract) tier of the data model definition associated with data sources, such first tier data objects may also be generated dynamically from the current data model definition and current data at the time a working data model is generated. Conversely, in some embodiments, it may be desired (e.g., for speed or efficiency reasons) to create and materialize a current data model that includes data objects for concepts in tiers of the data model definition other than the first (least abstract) tier of the data model definition (e.g., concepts in the first layer and the last layer of the data model definition). All such embodiments are fully contemplated herein.

It will be noted that because a working data model (and working data model definition) may be generated dynamically from a current data model definition only when (e.g., certain determined) concepts in higher tiers of the data model definition are required, changes to the data model definition itself may generally be easily made without impacting the currently materialized data model and without the need to re-generate any materialized data model. Moreover, the concepts of the altered data model definition may be utilized substantially immediately by users or applications. As soon as the data model definition is altered, this new version of the data model will be utilized in generating working data model definitions and working data models, taking these any defined (or removed) concepts and transformations into account accordingly (e.g., without having to regenerate and materialized data model).

Additionally, the data structures and methodologies utilized by embodiments may be similarly utilized with respect to providing versions of the data model Specifically, it has traditionally been the case that to store a version of a data model from a moment in time (e.g., an archived data model) it was necessary to persist the data objects of that version of the data model. In contrast, to allow embodiments of an inventory data system as disclosed herein to provide a data model associated with a specific time, embodiments may store snapshots of data from various time periods. These snapshots are just the state of the current data as it may exist at some point in time. Additionally, data model definition snapshots may be stored for various points in time (e.g., any time the data model definition). Again, these data model definition snapshots may include data model concepts according to order tiers (also referred to as layers) and a set of transformations (e.g., between each of the tiers) that define how to generate data for concepts in a subsequent tier from one or more concepts in one or more (objects of) previous layers of the data model definition

Thus, when a user desires a data model for a particular time, a version of the data model corresponding to that time may be dynamically generated by obtaining a data model definition snapshot associated with a previous time closest to the particular time desired, obtaining the data snapshot associated with a previous time closest to the particular time desired and applying the transformations to dynamically generate the data for the particular desired time. Moreover, only those portions of the data model for the particular time may be generated if desired. For example, a user or application can be presented with the ability to select or specify particular (e.g., higher level) concepts available in the data model definition snapshot associated with the particular desired time. Once these selected or specified concepts are determined, only data objects for the data model associated with those selected or specified concepts (e.g., the specified or selected concepts along with any concepts necessary to generate those specified or selected concepts) need be dynamically generated to provide the selected or specified concepts for that particular desired time. These specified or selected concepts can, for example, be generated in a similar manner to a working data model, as described.

As such embodiments provide specific types of data structures (e.g., data model definitions including tiers of concepts and transformations that can be utilized to dynamically generate working data models or versions of a data model, including data objects for various tiers in a data model definition) designed to improve the way computing platforms, including inventory data system, store, generate or retrieve desired data. Accordingly, embodiments may dramatically reduce the computational and storage overhead associated with traditional approaches to generating and using data models. By avoiding the precomputation, persistence, and repeated versioning of data models, including unused or marginally relevant objects, embodiments may enable on-demand data interaction without requiring complete materialization of a data model. Moreover, by decoupling model construction from rigid preprocessing pipelines, a dynamic framework may seamlessly incorporate new data sources, respond to evolving data structures, and adapt in real time to shifting data use requirements. Embodiments may also obviate the need for storing redundant model snapshots by enabling reconstruction of temporal states without duplicating the entire model for each version. Collectively, these improvements may mitigate many of the inefficiencies and structural limitations that encumber conventional data modeling, thereby enabling fluid, scalable, and context-sensitive interaction with complex, rapidly changing data ecosystems. Moreover, embodiments may allow use cases for data to be specified (or data to otherwise interacted with by users or applications) based on the semantics of the data desired for use by an application and allowing the defined use cases to drive the management (e.g., indexing, including processing or semantic contextualization) of data.

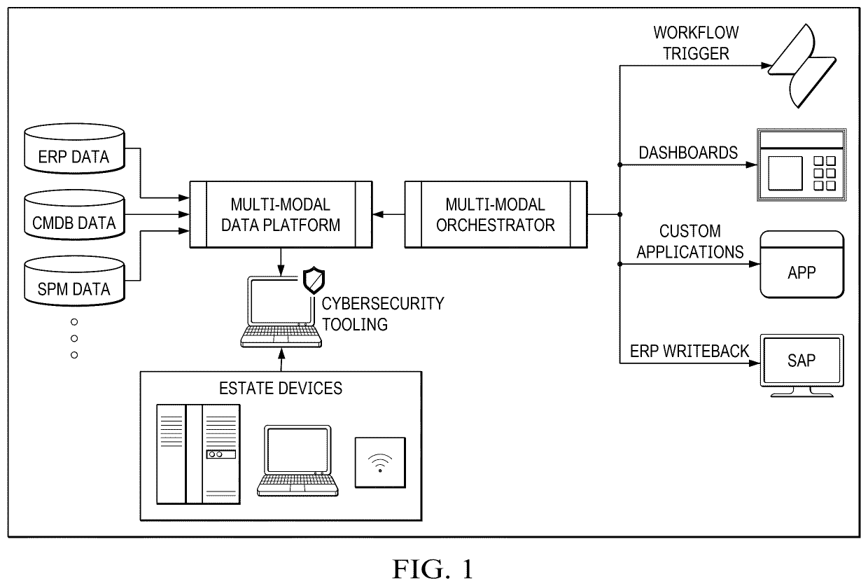

Referring then to FIG. 1, embodiments of a multi-modal (e.g., multi data source) inventory data system or platform (used herein interchangeably) is disclosed. Such embodiments may overcome the challenges discussed above, among others, by taking a far broader view of the available data, streaming, retrieved, or otherwise obtained from, multiple data sources in an enterprise and aligning this data from different sources (e.g., data from different sources can be aligned with or against one another). One key aspect (among others) in the approach of embodiments is aiming for the broadest possible coverage of the enterprise (where all physical or logical entities associated with the enterprise may be referred to generally herein as the “estate” of the enterprise), rather than just prioritizing accuracy (e.g., of individual entities in the estate). For example, by combining multiple data sources that are normally isolated (e.g., ERP/CMDB/SPM systems) and further enriching that data with additional data (e.g., low level cybersecurity monitoring data), an enterprise can get a much clearer view of their estate and make more informed (e.g., security or other types of) decisions. In particular, by actually allowing a higher level view of data that encompasses an overall picture of an enterprise's data, enterprises are enabled to make more informed decisions.

Embodiments of a multi-modal inventory platform as disclosed can thus consume an enterprise's data from these multiple data sources (e.g., ERP, CMDB and SPM systems) comprising data on the enterprise's estate, represent this data in an extensible data model (e.g., such as semantic graph), and detect the links between the relevant datasets. The data model may be a source semantic data model allowing an overarching view of an enterprise's data, regardless of the source. Moreover, such a data model may represent data from the multiple sources according to a common parlance, regardless of source, allowing such data to be interacted with according to those representations, regardless of source.

An embodiment then creates an intermediate view of the data which uses a common language targeted for use by the enterprise. Exposing this unified layer allows for multiple perspectives upon the same type of data from different source systems. An orchestrator layer included in embodiments as disclosed can thus query an enterprise's data (e.g., as represented in this data model) to identify patterns and results, including gaps: Where a device is missing from one or more sources; conflicts: where a piece of information is inconsistent between one or more sources and perspective aggregations: provide object level (e.g., objects representing a specific entity) aggregations at different perspectives (e.g., grouping IT service management data by ERP grouping).

Part of the data layer allows embodiments to link telemetry (live or frequent updates about utilization and operation) to business objects (e.g., slow moving, batch or manual updates). This allows embodiments to detect real time changes against known stale objects. Significant benefits of embodiments may thus arise from come from: a simpler, semantic data model that allows business to cross-correlate data from multiple sources; being able to receive live updates from lower level IT telemetry to get more frequent updates; using the cross-referencing to be able to identify upstream inaccuracies and improvements; and being able to give an up to date operational perspective that aligns with the slower paced business operational tools.

Again, one core distinction of embodiments is that they are diametrically opposed to a traditional inventory approach. Most inventory data systems are highly focused only on accuracy, which means that their modelling becomes more and more complex over time. This may allow for greater granularity. However, it comes at a cost of becoming less flexible and more use-case specific. Embodiments of the systems and methods as disclosed are instead focused on coverage: aiming to get the broadest possible data set to provide a higher level abstraction over the estate of an enterprise. In particular in certain embodiments, it is specifically the use of cybersecurity data to increase that volume that makes this unique. Historically such telemetry was captured purely for technical purposes and not made available to the wider enterprise. This ensured that high frequency data was used for limited purposes and not fully exploited for other needs.

Embodiments may thus have a number of advantages. One advantage of embodiments is the use of a data source semantic data model. In particular, traditional tools have a unique data model of a particular type of environment. These models are inherently focused on the outcomes required for the particular types of usage of that data. As an example, an SPM tool will focus on device objects, whereas an ERP will focus on departments. Merging these datasets requires multiple joins and is what can lead to gaps or discrepancies.

In contrast, embodiments as disclosed provide a semantic data model: a consistent view of devices (or other entities or data sources) across the enterprise's estate that can be used by all areas. The first advantage of this is that it allows for consistent reporting/discussions, since systems and methods may reference objects with a consistent language. The second is that such a data model allows areas of an enterprise to view their own estates through the lens of another. For example, it allows filtering Security Risk (SPM assets) by Department (ERP) or to track how the Applications (IT Service Management (ITSM) objects or other data ) interact with the end users (SPM devices) aggregated by Department (ERP).

Another advantage may be converged accuracy and writeback. As may be understood, ERP data provides the top level objects: departments, divisions and organizational structure. This data may be used for linking non-business data to a business context. CMDB data provides the “perceived state” of an IT services environment. This may be the initial dataset for linking business objects (e.g., as obtained from an ERP system) to concrete assets. In theory, the organizational structure in the CMDB should align with the ERP. In practice, this is rarely the case.

By providing a data model and system that allows correlation of data from data sources including different types of source systems embodiments may achieve certain advantages. This first correlation allows embodiments to infer and suggest cross-dataset inaccuracies and improvements at the process layer. Both ERP and CMDB records are treated as a source of ground truth for many business decisions. However they are manually updated, meaning their accuracy decays over time and often contains human error. By comparing these data sets, embodiments can detect inaccuracies and suggest fixes in the organization's “ground truth”.

As an example: the employee in the CMDB listed as owning a service 5 years ago may not work for the enterprise any more, or may have changed roles. Using the correlation, embodiments can provide recommendations of who would be a suitable replacement or provide a suitable decision maker with the ability to make corrections and adjustments. These adjustments are made upstream, writing back to the original data source of truth (e.g., the original source system including such data within an enterprise). This means that even tools not relying on the multi-modal inventory embodiments may gain benefits.

Another example of a correlation that can be obtained is between the SPM data and the CMDB data. These datasets contain records about concrete objects (devices) as well as abstract (services/applications). This allows embodiments to provide converged accuracy against the IT Service Management toolchain as a whole. This starts as a simple device check—in theory every device under security management should have an equivalent CMDB record (and vice versa). Device count mismatches between the datasets can then be added to a triage queue for remediation, again ensuring that the various business processes relying on these tools increase in their accuracy and effectiveness. Similarly, discrepancies on assignment, location and current state can also be notified and triaged. Given the volume of actions, the enterprise can choose to allow certain updates to proceed “in bulk” if they're deemed safe. As an example, if a flag is empty in one source but present in the other, simply process the update and notify the relevant owner.

Realtime updates are another advantage of embodiments. Here, having consumed and correlated these (e.g., three major) reporting lines (which may involve multiple sources of original data for each line), embodiments can then consume cybersecurity datasets. These datasets may already be collected by security and operations teams for a variety of purposes, some of which end up feeding the SPM tooling. Most security data is near real time, since every device is constantly sending telemetry. This can be used to provide useful business insights about a device without waiting for a human to take action and inform it. Network telemetry can confirm when a device is in a different location to that listed in the CMDB. User login data can confirm whether a device is in use by a particular team. These detections can be analyzed and surfaced to the relevant users for consideration, with different remits, feeding into the same writeback and data improvement loop as before.

Device utilization may also be determined and reported on by embodiment using data in the data model. This device utilization may include data pertaining to usage (or effective usage) of enterprise resources. In particular, combining operational records with cybersecurity data also provides embodiments much deeper insight into the utilization of specific or individual devices. A standard CMDB will allow service owners to track how many devices they are “managing”, but will leave it to them to discover if their capacity is sufficient. Infrastructure monitoring will provide a “by device” granular view, but this may not be suitable for a business decision. Taking the multi-modal approach of embodiments allow a user (e.g., associated with a business line) to view utilization in a metric that is comprehensible at a higher (e.g., business) layer but being based on the underlying data.

At a departmental/site (or other) level, this allows users to identify resilience risk (where the enterprise may have low on capacity) or optimization opportunities (where aggregate utilization is low). These data points can flow through to or from different sections or groups (e.g., the IT Service lines to the business lines), allowing them to have a common reference point for making decisions on usage or scaling. At a wider enterprise level, this allows for much more efficient decisions to be made about hardware investment. Being able to view assets at the holistic level, it is possible to consider the movement of devices between departments: moving hardware from those who have a surplus to those running a deficit. Such decisions may not be achievable using traditional tools: because the utilization is generally considered by ITSM on a by-device basis and business requirements are covered in isolated ERP processes. Traditional tools expect each IT Service to manage their own capacity requirements, which leads to over-provisioning.

By representing and using data regarding accounting process optimization, certain financial optimization may also be achieved through data analysis. Specifically, large enterprises may have multiple accounting processes which are largely based on inventory. Forecasting, budgeting, internal department recharging and tax credits are some examples. Converged accuracy will improve the accuracy of these processes, since errors in the ERP tools will be updated via writeback (e.g., updating data the source systems within the enterprise).

There are also several optimizations that can be delivered through the multi-modal approach employed by embodiments. One such optimization is related to license utilization. Software licensing can be a large cost for enterprises. Traditionally, licenses are granted to either “all team members” or “those that ask and are approved”. Both approaches can be wasteful, especially over time as users change roles or working practices. The multi-modal approach of embodiments can provide actual usage data, sourced from the devices themselves. This allows enterprises to confirm the actual utilization of a software product, and therefore provides opportunities to save money via license reduction, plan for future increases or even provide justification for dropping a license type in its entirety.

Another optimization relates to device purchasing and (device) stock forecasting. ERP systems will provide processes to order stock (e.g., hardware), which is normally based upon areas of the enterprise, departmental budgets etc. However, these often treat SKUs in isolation and most often purchasing is controlled on a case by case basis. Embodiments employing the multi-modal approach of embodiments allows these embodiments to view device requirements at a more holistic level: looking at organizational requirements rather than simply department or site. This allows for improved efficiency. In some cases, as above, it is possible to avoid unnecessary purchases simply by moving stock within the existing enterprise - providing an immediate saving. Where there is a purchase requirement, taking a holistic view allows the enterprise to also look for consolidation opportunities. In many cases, consolidating multiple smaller purchase orders into one could provide savings. Some of these are concrete in the form of vendor discounts, fewer shipping charges. However reducing the number of purchase orders also reduces the man-hours required to manage said purchases, and reduces the toil on the business overall.

Embodiments may also allow improved efficiency on support contracts by allowing insights that support amortizing device utilization across the estate, where it is easier to consolidate against a smaller pool of SKUs, meaning the possibility of simplifying support contracts and replacement processes. In some cases (such as R&D tax credits) the treatment of a hardware cost has different tax implications. Being able to accurately determine the use of hardware allows us to pre-calculate the items that should be listed for this (or other) tax reliefs and provide a report to finance for their convenience.

Embodiments may also provide advantages related to environment and network segmentation. Most critical IT services have a need to segregate their workloads into environments and networks (e.g., Dev, UAT, PROD etc.). These designations are often ITSM led, and exist normally in SPM tools using tags or similar. By consolidating the data to an Application/Environment level according to the multi-modal approach of embodiment these embodiments can actively track the network pairings within the estate (source/destination) and graph the relationships between the networks. This approach gives several advantages. By evaluating the traffic of “what have we seen”, embodiment can identify the exact combination(s) (e.g., classless interdomain routing (CIDR) and port) that are currently in use. Infrastructure as Code (IAC) may be generated which may then forcibly limit any specific network to those ranges. This is the first stage to proper segmentation of an open network: preventing any further exploitation. Moreover, once embodiments have determined which networks are involved in which environment, these embodiments can detect where there is invalid cross-correlation (e.g., a development entity talking to a production entity) and highlight these for security review.

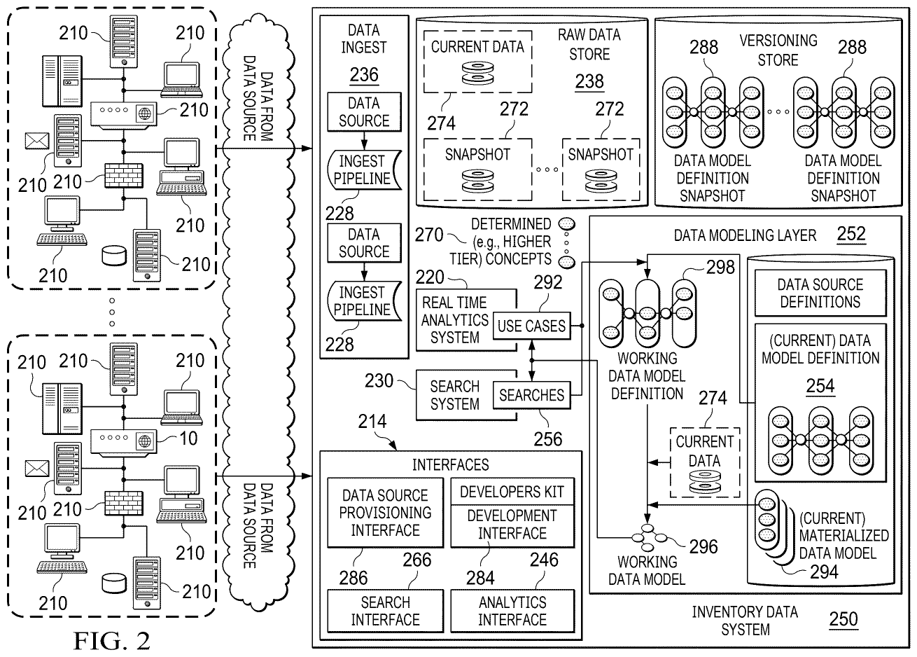

Embodiments may be understood with reference to FIG. 2, where one embodiment of a network topology including an embodiment of an inventory data system 250 is depicted. Inventory data system 250 may be adapted to manage data associated with one or more enterprises (e.g., any for profit or non-profit entity that employs computing resources or infrastructure). An enterprise may comprise a set of heterogeneous data sources 210 that may be distributed across the enterprise (e.g., at various sites, domains or locations associated with the enterprise). These data sources 210 may comprise any source of data that can be identified with a point of origin such as network infrastructure devices, network management systems, software services, security services, applications, logs, etc.

To manage data originating from these data sources 210, inventory data system 250 may employ data modeling layer 252. Data modeling layer 252 may include a (current) data model definition 254, searches 256 defined by a user (e.g., using search interface 266), queries submitted by a user or application 272, use cases 292 (e.g., defined by a user through a development interface 284 using a developers kit or the like). Inventory data system 250 may utilize semantic layer 252 to illuminate data from data sources 210 with a semantic context based on semantic data model definition 254 and route this contextualized data to various systems or applications that make use of that data such as real time analytics system 220 or search system 230 (or otherwise provide such data, such as in response to a request through an interface or the like).

The data model definition 254 thus includes a set of concepts organized as a set of (ordered) tiers, each tier comprising a set of (semantic) concepts, where the concepts in one tier are mapped to the concepts in a subsequent tier. The tiers comprising the (semantic) data model definition 254 may be ordered based on the level of abstraction represented by each tier (e.g., from more specific to more general or abstract) such that the first tier of the (semantic) data model definition 254 may represent more specific concepts for data normalization while the last tier of the (semantic) data model definition 254 may comprise the most general or abstract concepts for semantic normalization of data. The concepts included in each tier of the (semantic) data model definition 254 may be mapped (e.g., associated with) one or more concepts in a subsequent (e.g., more abstract) tier in the semantic model. As may be imagined there may be almost any number of intervening tiers between a first tier and a (most abstract) semantic tier of a (semantic) data model definition 254. Moreover, there may be additional layers of a (semantic) data model definition 254, such as layers including representation of applications that may consume data or how data is to be presented.

In one embodiment, a (semantic) data model definition 254 may include a (e.g., least abstract) first tier comprising a raw data or data source tier including a number of concepts representing specific sources of data, (e.g., including the data schemas, fields, specific device configurations, models or versions of software, specific services or programs, etc. of those data sources), and a (more abstract) semantic tier comprising a number of concepts representing the normalization of the semantics of data, such as concepts representing a type of the data, or a type of data source from which data can originate.

When a data source 210 is provisioned at inventory data system 250 (e.g., when the inventory data system 250 is configured to receive and manage data from this new data source 210) a user may provide data source definition data to the inventory data system 250 (e.g., through data source provisioning interface 286). The provisioned data source 210 can then be associated with a concept in (semantic) data model definition 254 representing the specific type or configuration of that data source 210. In this manner, data objects associated with concepts associated with a provisioned data source 210 can be created to represent that configured data source 210.

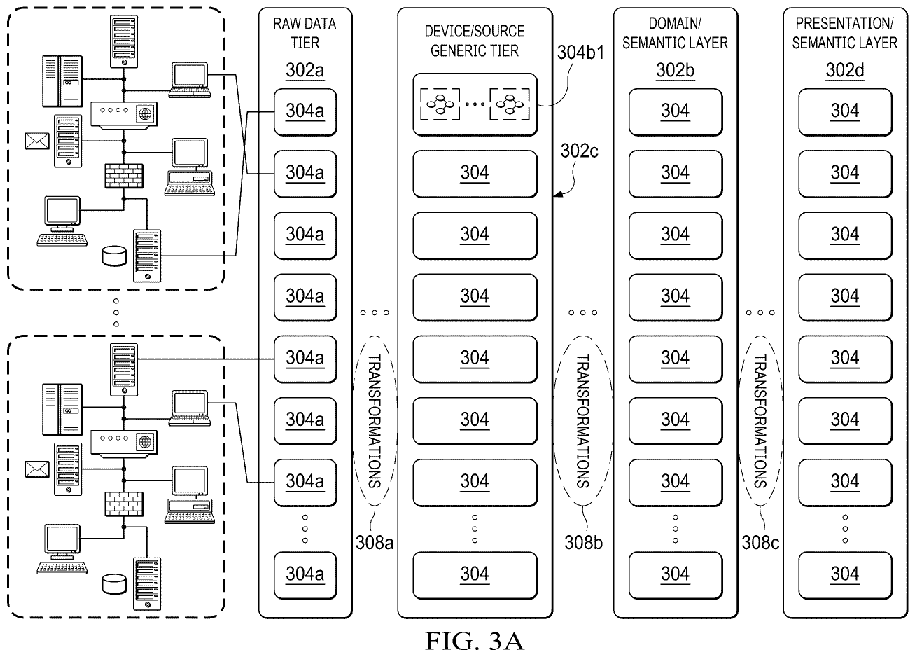

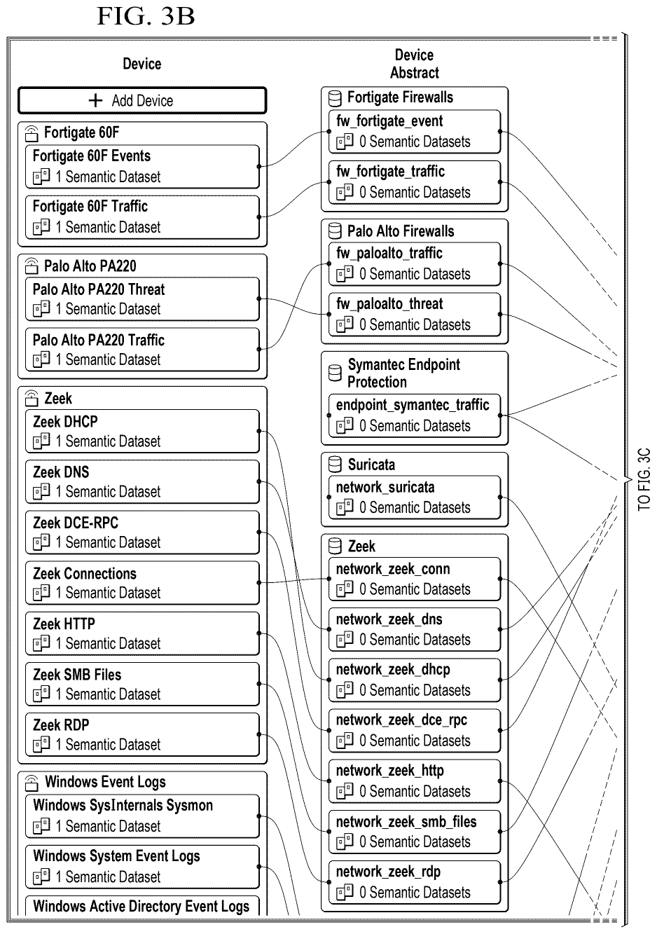

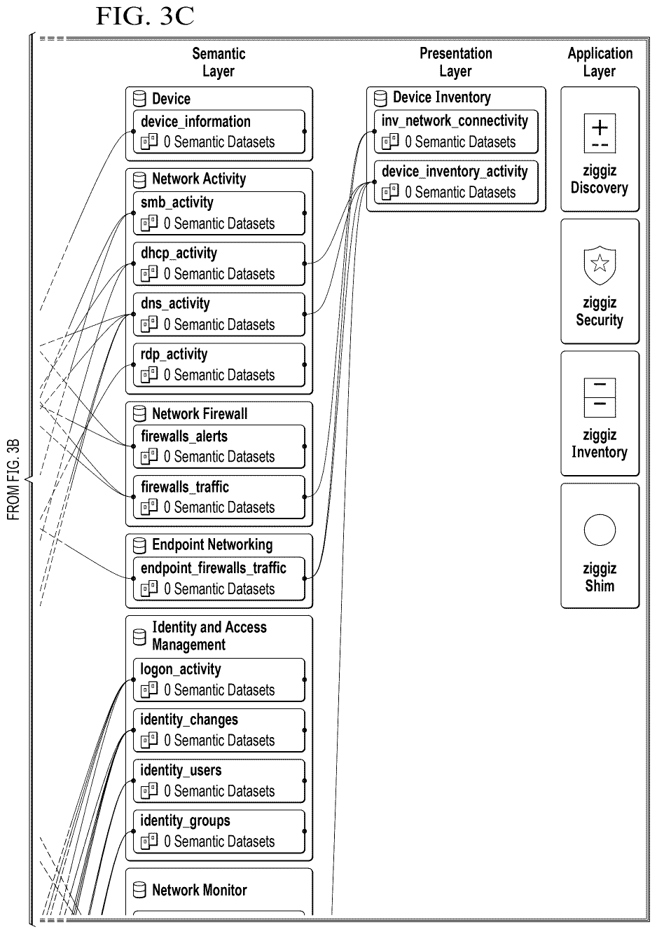

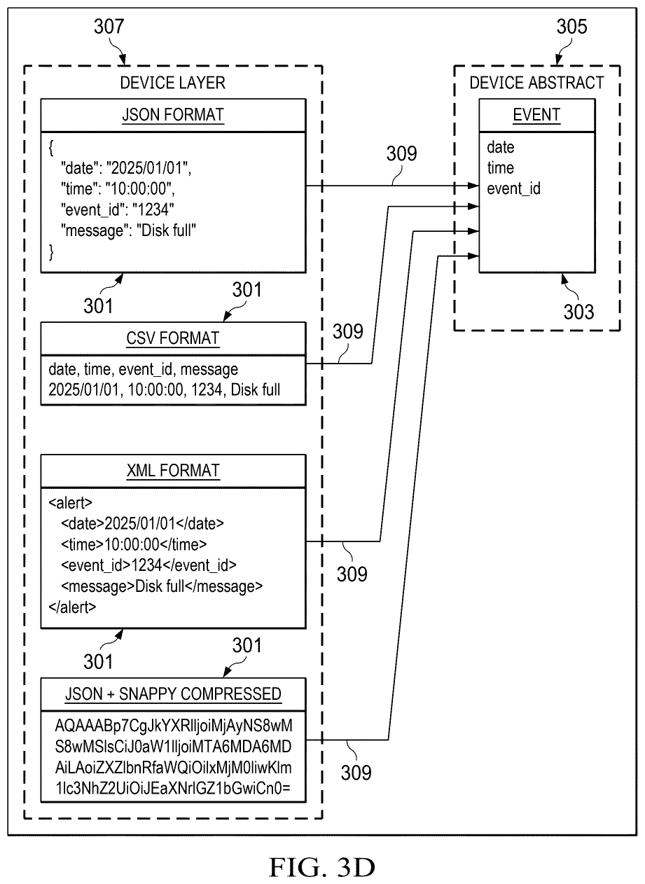

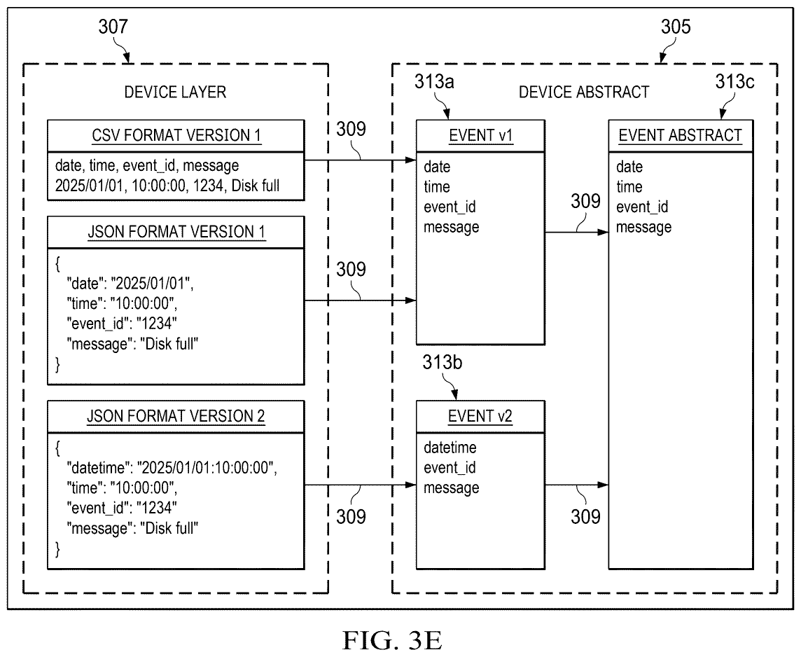

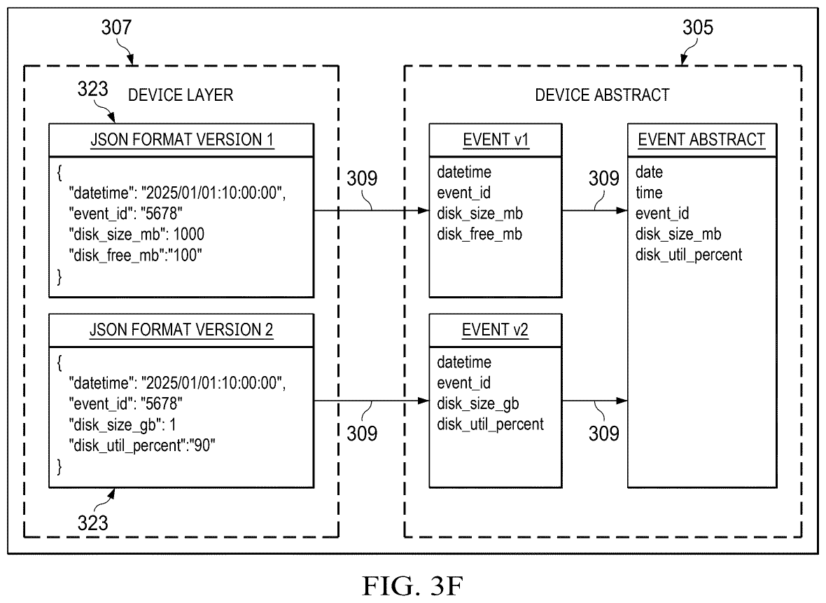

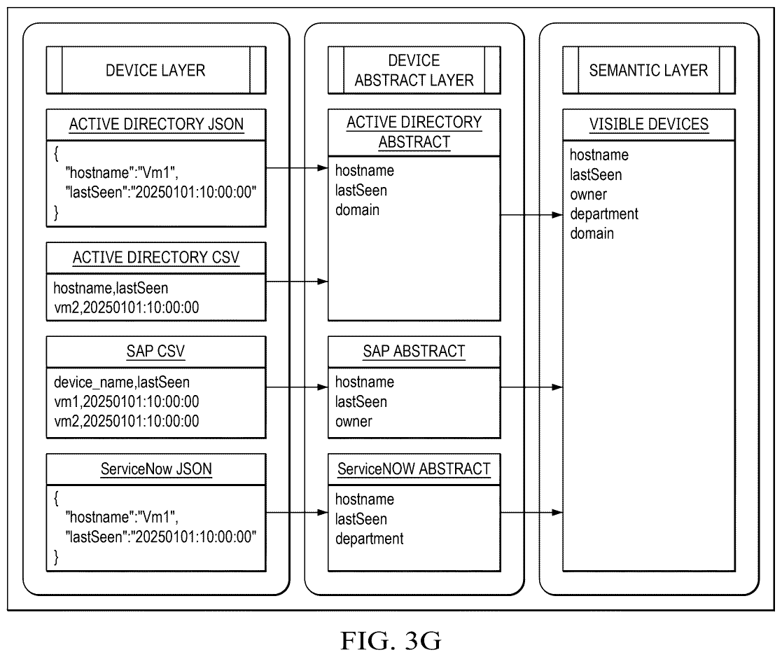

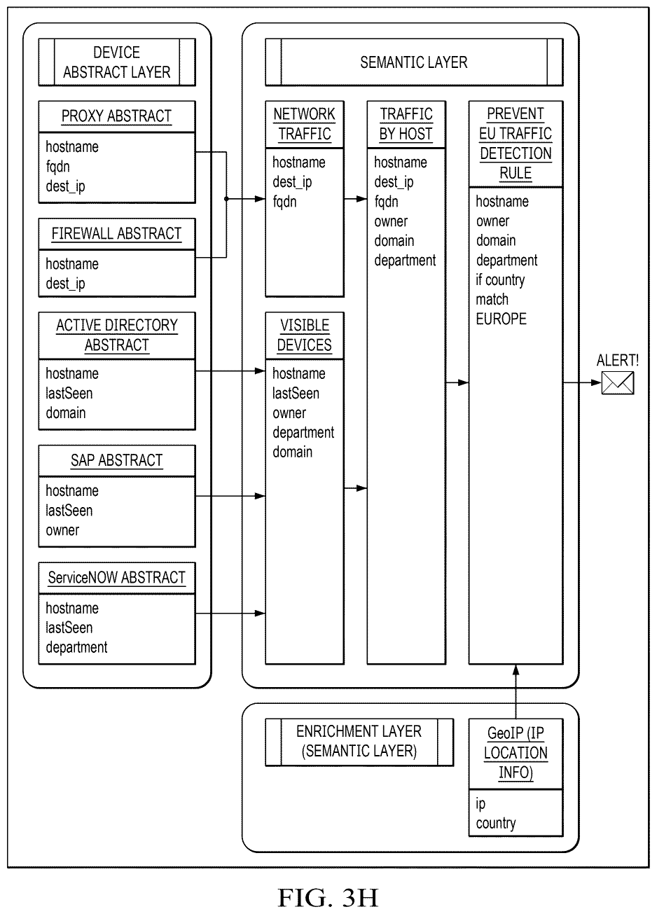

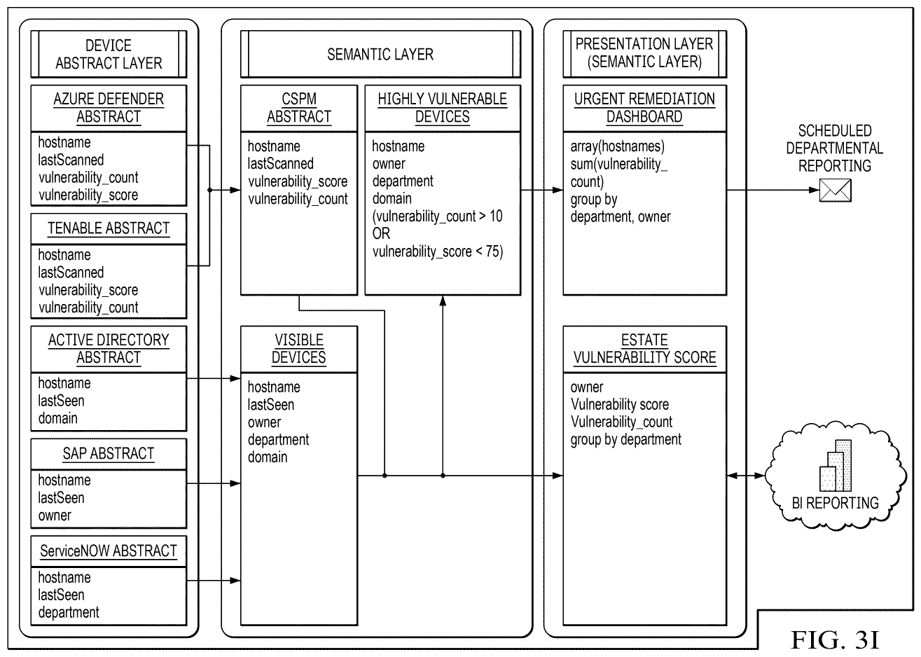

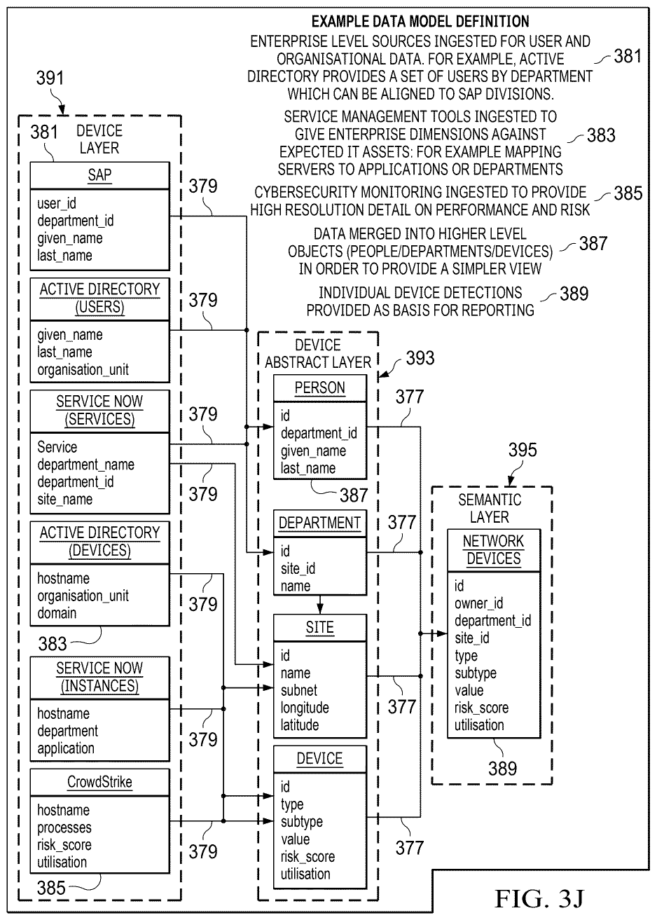

It may be useful here before proceeding further to discuss embodiments and examples of such data model definitions (referred to as semantic model definitions) in more detail. FIGS. 3A, 3B, and 3C depict examples of such semantic model definitions. Turning first to FIG. 3A, a generalized depiction of one example of a semantic model definition is presented. In this example, semantic model definition 300 include a (e.g., least abstract) first tier 302a comprising a raw data or data source tier including a number of concepts 304a representing specific sources of data, (e.g., including the data schemas, fields, specific device configurations, models or versions of software, specific services or programs, etc. of those data sources), and a (more abstract) semantic tier 302b comprising a number of concepts representing the normalization of the semantics of data, such as concepts representing a type of the data, or a type of data source from which data can originate. There may also be a semantic tier 302d comprising a presentation or application layer that included concepts 304 representing data as it may be presented or interacted with by users or applications.

Concepts 304a in the most specific tier 302a of the definition 300 associated with specific data sources can thus be defined in a least abstract layer and individual data sources 310 configured for an inventory data system associated with those concepts 304a in the least abstract tier 302a. In some embodiments, there may be one or more middle tiers 302c of the data model definition that represent varying levels of abstraction, such as a (source generic) tier representing generic data sources and including concepts that group data sources by criteria associated with those data sources including, for example, vendor criteria, manufacturer criteria, hardware criteria, software criteria (e.g., software type or version), criteria associated with a type of data provide, interface criteria, or other criteria. Additionally, each concept 304 (e.g., concept 304b1) may encompass one or more other concepts (or sets of concepts) such that each concept 304 may form a subgraph of the semantic model 300.

Transformations 308 may associate concepts across tiers 302 illustrating how data sources and data items from those data sources may interrelate through data lineage and transformations. Using the transformations between the tiers 302 and the mapping of data sources 310 to concepts (nodes) 304a in the least abstract layer in the first tier 302a, such a semantic data model definition 300 may be traversed (e.g., in a reverse direction) starting with concepts 304 in the most abstract tier (e.g., 302b or 302d) to determine all data sources 310 or semantic concepts 304a in that least abstract tier 302a associated with any semantic concepts in that most abstract tier 302b.

A data model definition can thus include a set of transformations that define how to generate data for concepts in a subsequent tier from one or more concepts in one or more (objects of) previous layers of the semantic model definition. These transformations can, for example, map one or more concepts (e.g. fields of various objects) included in a previous (e.g., less abstract) tier of the data model definition to one or more concepts (e.g., fields of various objects) in a subsequent (e.g., more abstract) tier in the data model definition. These transformations can include direct (e.g., one to one) mappings between concepts in the tiers or indirect mappings that define processing or manipulations to be performed on values for one or more concepts in one or more objects included in a previous (e.g., less abstract) tier of the data model definition to one or more concepts (e.g., fields of various objects) in a subsequent (e.g., more abstract) tier in the data model definition.

Direct mappings may, for example, indicate that the value for a concept of an object in a previous (e.g., less abstract) tier is to be used as a value for a concept of an associated object in a subsequent (e.g., more abstract) tier. Indirect mappings may define processing or manipulations to be performed on values for one or more concepts in one or more objects included in a previous (e.g., less abstract) tier of the data model definition to one or more concepts (e.g., fields of various objects) in a subsequent (e.g., more abstract) tier in the data model definition. Such indirect mappings may, for example, indicate that values for one or more concepts of one or more objects in a previous (e.g., less abstract) tier are to be used to determine a concept of an associated object in a subsequent (e.g., more abstract) tier and a transformation definition defining how the value for the concept in the associated object in the subsequent (e.g., more abstract) tier is to be determined. These transformation definitions may include rules on how to combine the values of the one or concepts of the one or more object to generate a value for a concept in the subsequent tier, how to select between the values of the concepts from the previous (less abstract) tier, data transformation to be performed on the values, or other rules for determining the value for the concept in an object in a subsequent (e.g., more abstract) tier of a data model from values from one or more concepts in data object of a previous (less abstract) tier.

Accordingly, the semantic model definition 300 and data models generated from such a semantic model definition 300 utilized by embodiments may be thought of, or represented as, a graph, where each tier 302 of the semantic model definition 300 comprises a set of nodes representing the concepts 304 associated with that tier 302 and the transformations 308 between the concepts of each tier 302 are represented by edges of the graph. In particular, a data model created from the semantic data model definition 300 used by embodiments may be thought of as a directed graph, where the set of nodes representing the concepts 304 in a more specific tier 302 are joined by directed edges to the one or more nodes representing concepts 304 in a subsequent more abstract tier 302 to which those nodes are mapped (e.g., a directed edge is included in the graph from a node in a less abstract tier to corresponding node in the more abstract tier to which the node of the less abstract tier is mapped).

In some embodiments a first least abstract tier of the semantic model definition may include a device tier representing raw data feeds from specific device models and versions (e.g., Fortigate 60 F v1.2.3 ) and abstract data sources, such as SaaS services. A middle tier may include a device abstract layer grouping data sources, such as devices, into product types by vendor or other criteria (e.g., Fortigate Firewalls). A most abstract semantic tier may include any concepts that serve to normalize data by semantics rather than vendor or source (e.g., Network Activity, Network Firewalls). Each tier may thus comprise nodes that represent data sources, datasets within those sources and individual fields (items) within those datasets. Edges in the graph represent transformations between concepts (e.g., data items or fields) across layers, representing how data sources interrelate through data lineage and transformations. FIGS. 3B and 3C are a depiction of such a semantic data model.

It may be useful here to discuss embodiments of semantic data model definitions in more detail. As discussed, a semantic data model definition may include a number of layers (or tiers) that include concepts for representing different degrees of abstraction. A semantic layer for such a data model definition may thus comprise concepts reflecting a union of multiple previous abstractions in a previous (less abstract) layer of the data model based on transformations that may include filters and or combination logic. One of the main benefits to such a data model definition is the incorporation of such filters and combination logic within the data structure and modeling flow, rather than being defined by the consumers of such data which may be myopic with respect to the form or content of their data.

Thus, a data model definition may also comprise a least abstract device layer which may include concepts reflecting the concrete implementation of data sources. These concepts may represent the data engineering for conversion of source data from data sources into a desired schema (e.g., a columnar schema). This first (most specific) layer is adapted to handle the core data engineering of a data model. Essentially the transformation of raw data from data sources into a standardized schema. Since embodiments of an inventory data platform handle raw data ingestion from external feeds, they do not control the input: the format, schema, ordering, compression and other factors all create different data engineering tasks. The initial device layer of a semantic data model definition is therefore adapted to represent a concrete instantiation of a data transmission type. This includes amongst other things: data structures, data types, data formatting, encryption or compression of the data from various data sources.

A next most abstract layer may be a device abstract layer. A device abstract layer may include concepts reflecting a union of specific device layer concepts, to create a consistent base view that represents a data source type irrespective of concrete implementation. This device abstract layer can include concepts related to, for example, abstraction between source transport types, handling drift between schema versions or consolidating units/semantic objects into a consistent base class.

As can be understood then, inventory data may be harvested from various data sources by embodiment of an inventory data system and represented in a semantic data model according to an agnostic semantic data model definition (e.g., agnostic to the schema of the various data sources or the format in which the data is otherwise maintained or manipulated by the underlying data sources). The convergence of the data sources in such an agnostic semantic data model creates large “unified” data sets, with different levels of resolution. The data from these different data sources may have different column names, data types and meanings. For example, two different security tools may use different names for the computer's IPv4 network address (e.g., ip, ip_addr, ip_address, src_ip). Embodiments of an inventory data system as presented will unify (e.g., all) these columns from within the underlying data from these data sources and present a single name to the end user (for example: ip_address). This means that queries (or other interactions) against the data as represented in a data model according to a semantic data model definition need only be written once per semantic object and the inventory data system will correctly obtain the relevant data from lower level data sources (despite that it might be referred to by another name in that lower level data source).

In doing so, embodiments ensure that all dashboards/reports and other outputs from an inventory data system are consistent in their naming convention and taxonomy. This alignment allows for (e.g., cross-department or area) search and visualization. To implement this as a semantic model definition embodiments may account for the core variety of objects. Specifically the embodiments may account for and provide high level representation for at least four core elements: 1) devices (e.g., a physical object that is under management or supervision); 2) people: (e.g., a person can be an owner of a device, a user of a device or the manager of another person); 3) departments (e.g., any organizational unit of an entity); and 4) sites (e.g., physical locations or infrastructure such as areas of an enterprise such as those where devices or people may be present). In some cases, the data model definition may deliberately avoid trying to classify inheritance to avoid complexity.

FIG. 3D depicts one representation of a portion of definition for data objects in an example data model definition comprising example objects in a device layer 307 and a device abstract layer 305. As may be realized an event concept 303 in a device abstract layer 305 can be generated for payloads received according to each of the data source definitions 301 in a device layer 307 and these events may be identical objects (e.g., of the same object type) but the data received for each of those events may be completely different. Transformations 309 thus define how to map data in each of the different data source definitions to the same event concept 303. Accordingly, each representation is a separate data engineering task. By consolidating representation of these raw engineering tasks into the initial layer, a user of higher level concepts in the semantic model need not be concerned with implementation details of the originating data source system. This means that there may be many different concrete types (definitions for data objects) that represent the same underlying object. In this example, the data structure for the event remains consistent but the transportation wrapper is different. Thus these data model definitions can be extended or manipulated or otherwise used to cover issues around schema drift and semantic collisions.

Schema drift occurs when the upstream system changes its data structure. This can include Adding/Removing columns or changing data types. A simple example is depicted in FIG. 3E From a concrete implementation perspective, event v1 concept 313a and event v2 concept 313b are different: the number of elements has changed as has the type. Therefore this may require 307 a new device layer (or one or more new concepts to be added or concepts changed in the device layer 307). Fundamentally, the semantic meaning of the data has not changed. The event ID for the metric remains relevant. The device abstract layer 305 handles this by encapsulating the logic required to convert from specific data structures to a device level abstraction. This means that embodiments of the inventory data platform can support data sources that provide feeds comprising events having data formatted according to the event v1 concept 313a and event v2 concept 313b. In other words, while the device layer 307 concepts may change or otherwise be altered, the reporting path of the device abstract layer may remain consistent by abstracting that data in an event abstract concept 313c using transformations 319.

Semantic collisions may occur when two or more data points have the similar concepts including multiple data points that cannot be aligned. In the example of FIG. 3F, version 1 and version 2 are both reporting disk consumption. However they use different measurement units (MB vs GB) but also their reporting dimensions differ (e.g., utilized versus free space). It is very easy when combining lists of similar datasets from disparate sources to compare the wrong elements or units, and therefore include incorrect data. This is where the device abstract layer 305 may be useful. Since concepts of the data abstract layer 305 can be consolidating data across versioning to provide a unified data model, it can enforce a single mode of truth using transformations 309 that define how data from concepts are to be mapped to other concepts. In this case, one column is accepted as each from the device layer concepts 323, whilst there is a data transformation 309 upon the second column to align the data across the estate.

Embodiments of a data model definition may also comprise a layer more abstract than the device abstract layer referred to as a semantic layer. A semantic layer may comprise concepts that may be a union of device abstract layer concepts. In particular, a semantic layer may comprise union of multiple concepts into a single consolidated view (e.g., a collation of similar concepts). For example, types of semantic layers may include, foundation abstract layers, authoritative layers, enriched layers, reporting layers, detection layers or reporting layers. A foundational abstract layer may be a type of semantic layer that includes concepts that incorporate multiple device abstract concepts and merging them into a superset based on inherent similar properties. For example, merging three different types of firewall data sources into a “firewall” table. This may be referred to as foundational because it is these core abstract classes that make future reporting simpler and easier to manage.

An authoritative layer may include concepts associated with a data source that is considered an authority on a specific area of data. This might be an external data feed, threat intelligence or database tables for staff movements. These are generally fact tables instead of events. These concepts in the authorities layers can be combined with others to create enriched layers which may include concepts that combine concepts from multiple different semantic layers to provide enrichments. These enrichments may be table or column level matching and are not limited to a pair at a time. This means that a single data source can be enriched from multiple data sources simultaneously.

A reporting semantic layer involves concepts that may represent aggregations or groupings over various dimensions. These may be distinct from event based layers and have different compute requirements. A detection layer may be a layer of concepts that may be utilized to track a specific set of conditions: generally either by filtering out non-critical events or using a previous enrichment layer to remove false positives. These are then useful for building analytics (e.g., detections) upon since the filter complexity is abstracted into the data layer rather than the query language. A presentation layer may be a semantic layer that may be a most abstract layer including concepts designated for user of application consumption outside of the inventory data system. A presentation layer may, for example, focus on a specific data product for downstream data consumption, and so may cover column level transformations to handle the specific quirks of the user of the data (e.g., application). A presentation layer may also be a layer where any formatting transformations are handled for external requirements.

FIGS. 3G-3I depict examples of portions of example semantic data model definitions including example concepts at different layers, including a semantic layer. Looking at FIG. 3G, one example of a portion of a semantic data model definition is depicted. Here, there may be multiple sources of (e.g., inventory) data, each including various data about hostnames. The semantic model definition utilizes the device and device abstract layer to handle the data engineering, which means that data from the data sources will be coerced into confirming with an internal data contract represented by the device abstract layer. The inventory data platform can then create a “visible devices” table from the visible devices concept in the semantic layer that is agnostic as to which data source last saw the device, but provides the inventory data system with the current known state. Accordingly, any searches/reports/dashboards/analytics, etc. built on this semantic layer (e.g., on the visible device concept) will survive any underlying migration of data sources. This is because the data contract is within the platform and retained at the device abstract layer—so any new data source merely needs to be correctly mapped to the semantic layer and existing reporting will be consistent.

Moving now to FIG. 3H, another example of a portion of a semantic data model definition is presented. It may be apprehended that there are many types of data sources that provide data according to particular formats that are somewhat user agnostic such as threat-intelligence, pricing feeds, CVE scores etc. Traditionally, users are forced to handle their own integrations with such data feeds (e.g., how to process or utilize such data). Embodiments of an inventory data platform handle this by integrating at the semantic layer rather than at the device layer. This reduces the load on data engineering tasks whilst also allowing users the benefit of consistent enrichment.

FIG. 3I depicts an example of a portion of a semantic data model definition that may be associated with detection. Detections may be a critical part of any tool processing event data. Traditionally, security alerts start simple (flag on all traffic containing “X”) and then over time become significantly more complex to cover edge cases and dampen noise. However, using a semantic layer of a semantic data model according to embodiments, the alert query complexity can be replaced with a semantic layer (e.g., concepts) designed or adapted to track a specific desired type of detection. This means that the underlying data set is pre-filtered whilst also ensuring that edge cases and reports are consistent, rather than relying on a user keying in a correct search each time data needs to be evaluated.

As depicted, semantic layers can contain multiple stages. In this example, concepts are included in the semantic layer of the semantic data model definition that can model various stages of transformation for different data requirements. Notice that since semantic layer concepts are built on concepts leveraging concepts of previous layers of the data model definitions, concepts such as aggregations and dimensions become easier to work with, since they are consistent within the semantic layer.

FIG. 3j illustrates this in more detail using a portion of a semantic data model definition. As depicted there may be concepts in the device layer corresponding to enterprise level sources 381, service management tools 383 and cybersecurity monitoring tools 385. The concepts can be transformed using transformations 379 into concepts such as person, department, site device 387 in the device abstract layer 393 to provide a more abstract view of that data. These concepts in the device abstract layer 393 can then be mapped to concepts in the semantic layer 398 using transformations 377 representing an abstract network device 389 that can be used for detections on a device and reporting/analytics.

Now that semantic data model definitions and associated data models that may be generated from these semantic data model definitions are better understood, attention is now returned to FIG. 2, data sources 210 are provisioned at inventory data system by providing data source definition data to the inventory data system 250 (e.g., through data source provisioning interface 286) and the provisioned data source 210 is associated with a concept in data model definition 254 representing the specific type or configuration of that data source 210. An ingest pipeline 228 for the data source 210 comprises a (inventory data system internal) schema for storing or using data from that source 210 and one or more extraction pipelines 228 adapted to extract data from data received from that data source and, if needed, transform that data for storage according to the internal schema for storing or using that data.

Data from a data source 210 can thus be provided according to the current data model definition 254 when, and (e.g., only) if, such data is needed. Specifically, data may be provided to components of the inventory data system 250 according to the current data model definition 254 as that data is needed by those components. Desired data may, for example, be defined or requested by such components.

In one embodiment, these components may include a real time analytics system 220 and a search system 230. Specifically, real time analytics system 220 may allow use cases 292 defining data sets where these use cases for data may be specified based on the semantics of the data desired for use by an application (e.g., through development interface 284). The semantics may be specified according to concepts defined in current data model definition 254. Similarly, search system 230 may allow searches 256 to be defined (e.g., through search interface 266), where those searches define data sets based on concepts of semantic concepts that it is desired to search. The semantics may be specified according to concepts defined in current data model definition 254.

As data is received from these various data sources 210 configured at the inventory data system 250, this data may be received by data ingest module 236 and stored in the raw data store 238 (e.g., in its original form). The data received may be stored in the raw data store 238 in association with a time stamp (e.g., indicating when the data was generated, received, stored, etc.) such that data from individual data sources 210 may be obtained according to a time based query or the like.

Thus, raw data store 238 may include a current set of data 274 received from data sources 210 over some time interval. Moreover, snapshots 272 of data from various data sources 210 may also be stored in raw data store 238. These snapshots 272 may comprise of the data as it existed at a point in time (or time interval) in the past. In certain embodiments, data storage for embodiments of an inventory data system according to embodiments may be implemented using a data connection layer for connecting to data sources (e.g., to external storage or through APIs of those systems). Embodiments may also utilize a cloud based computing environment for storing or processing such data such as by using cloud based object level storage (e.g., S3/Azure Blob etc.) for data storage. In one embodiment, data may all be in column based storage with some form of metadata. An example of two such formats are Delta Lake and Apache Iceberg.

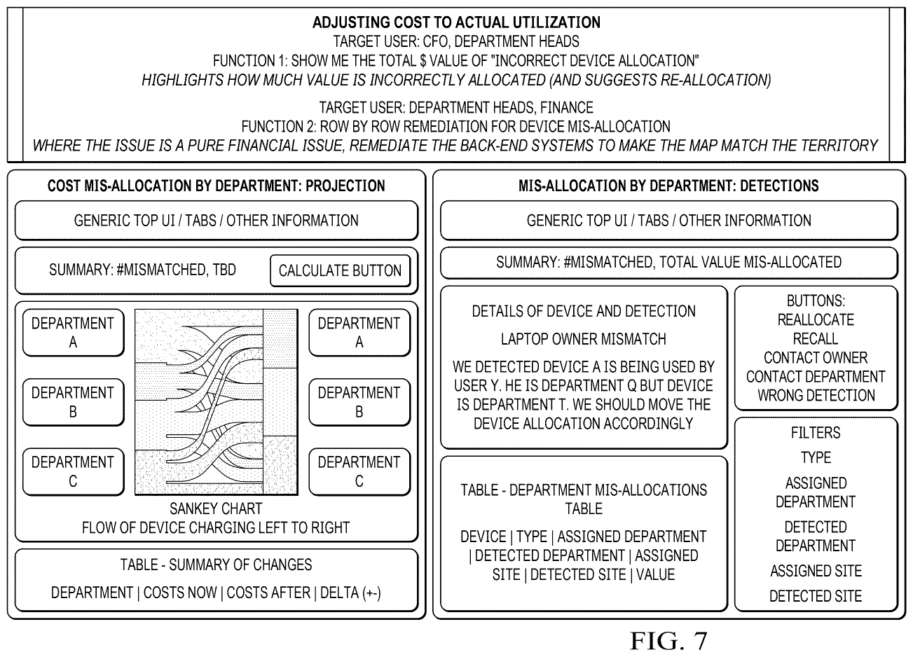

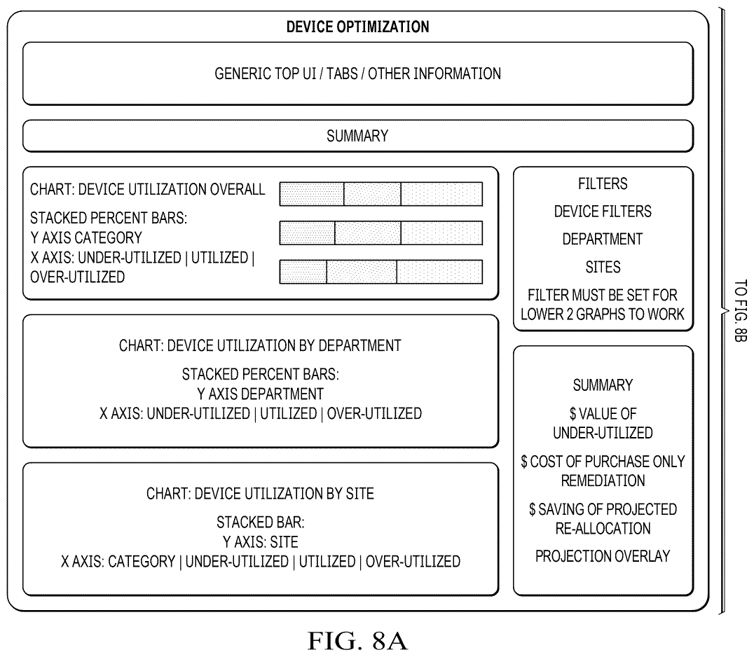

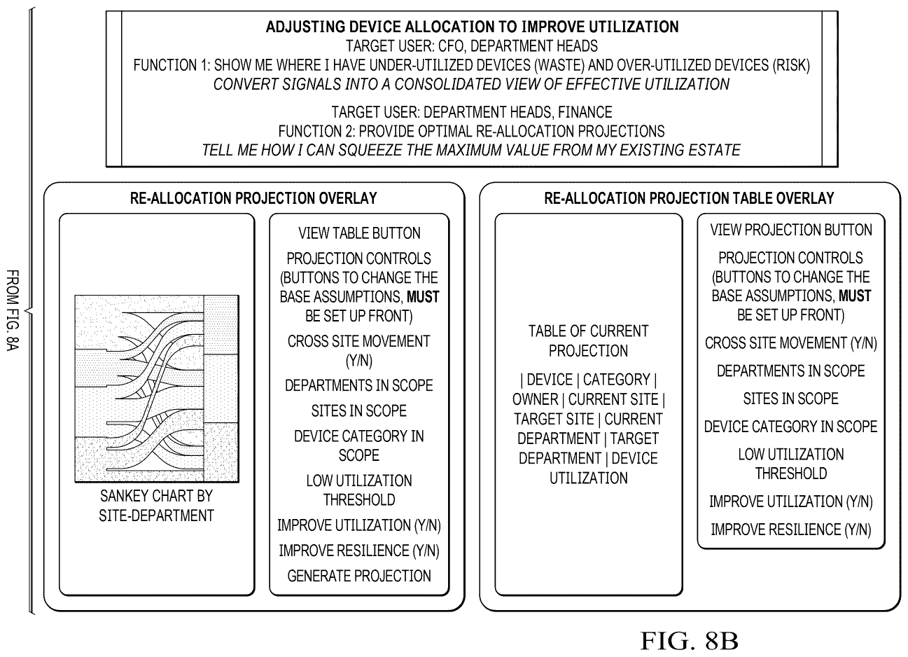

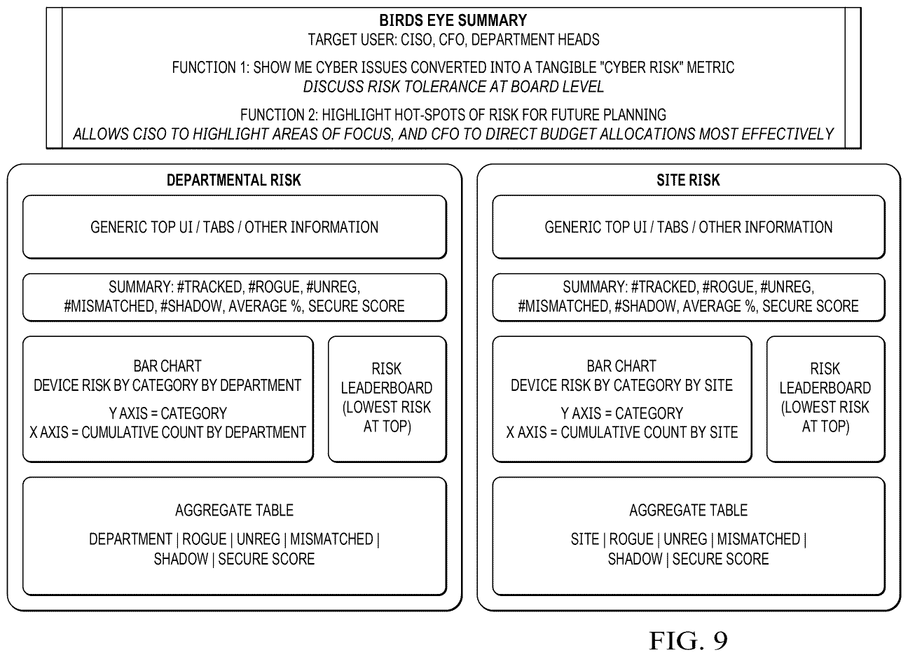

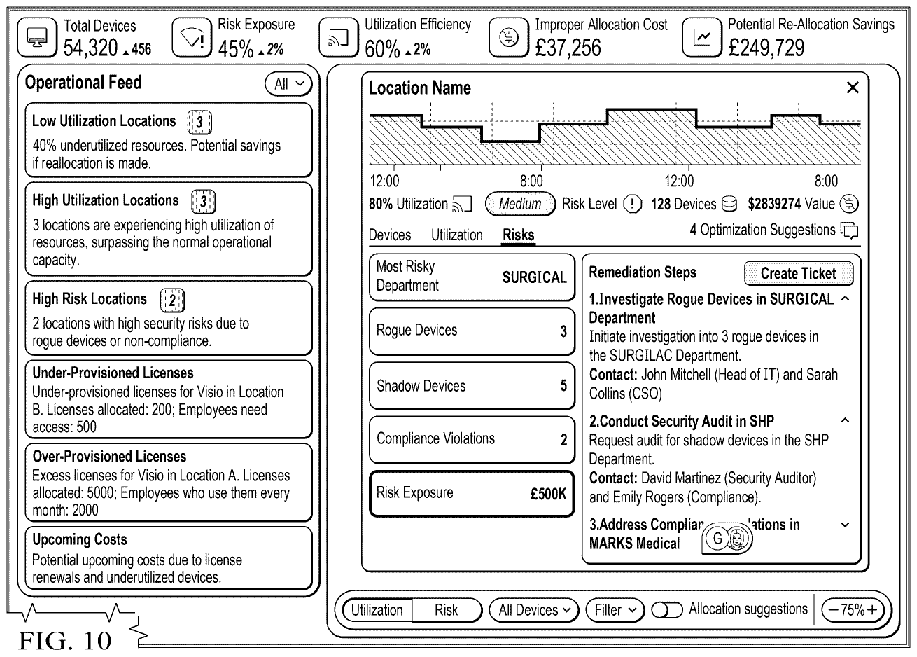

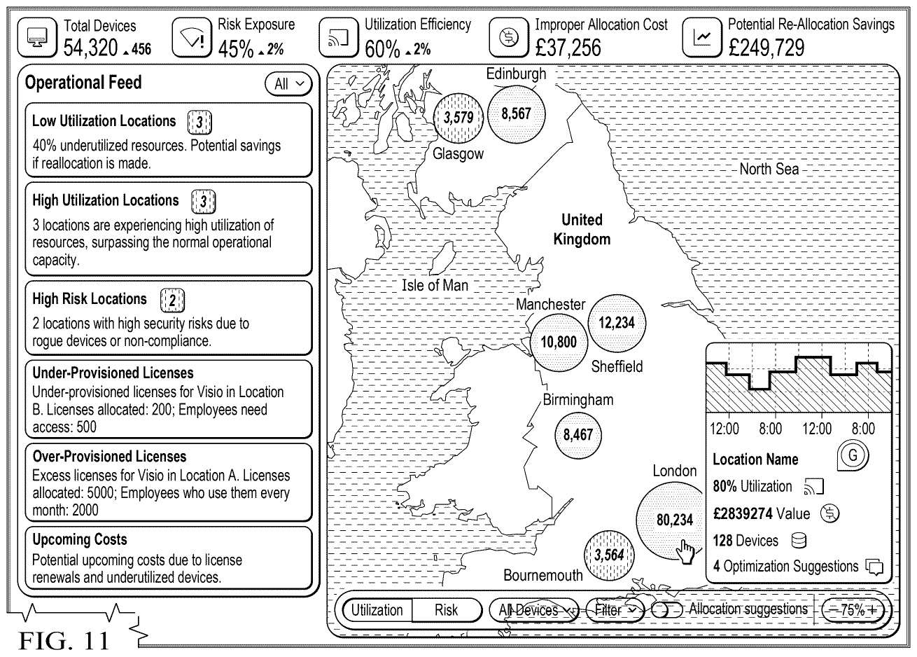

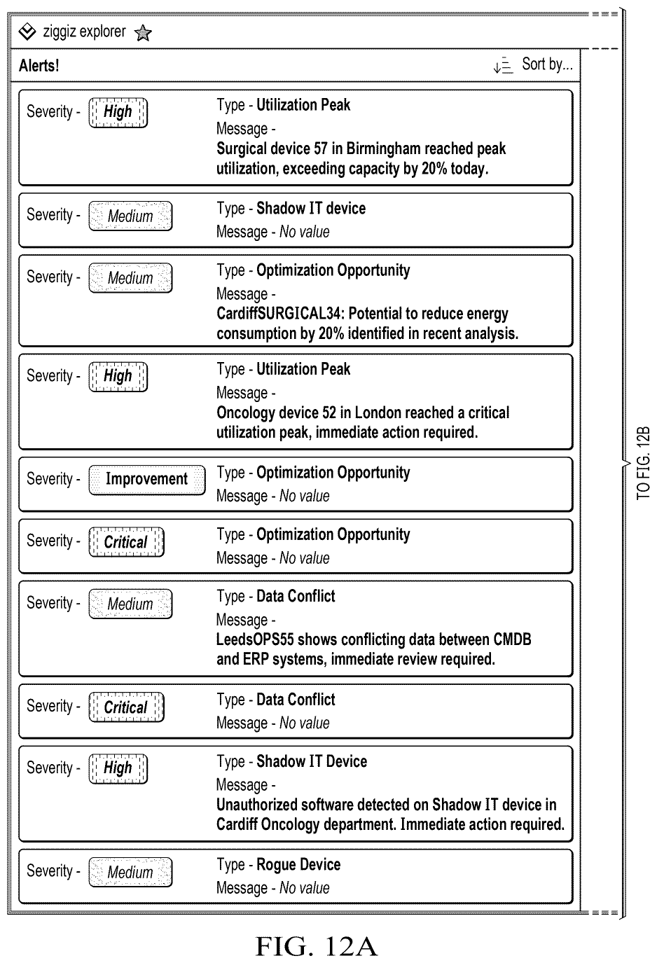

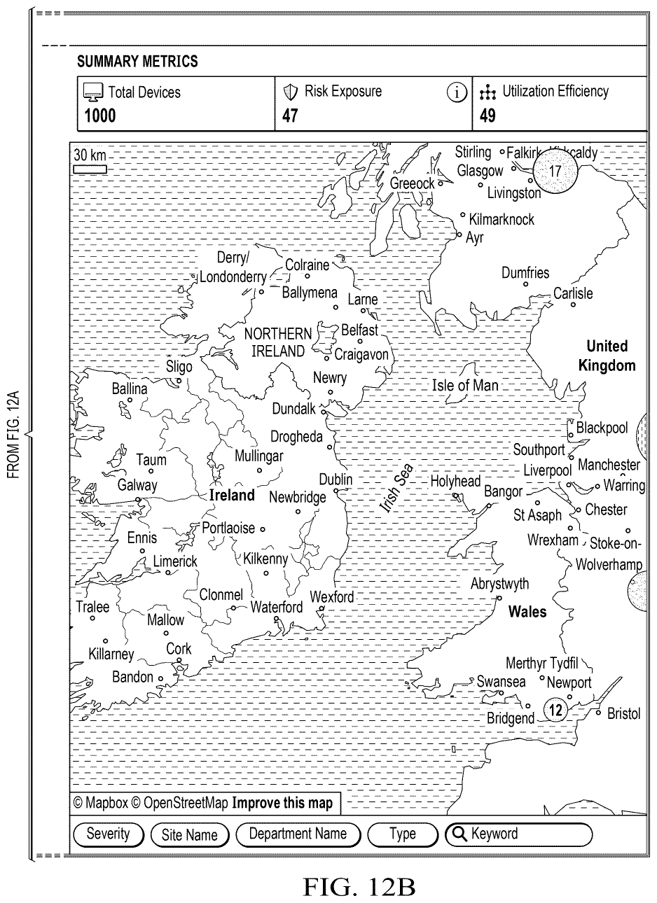

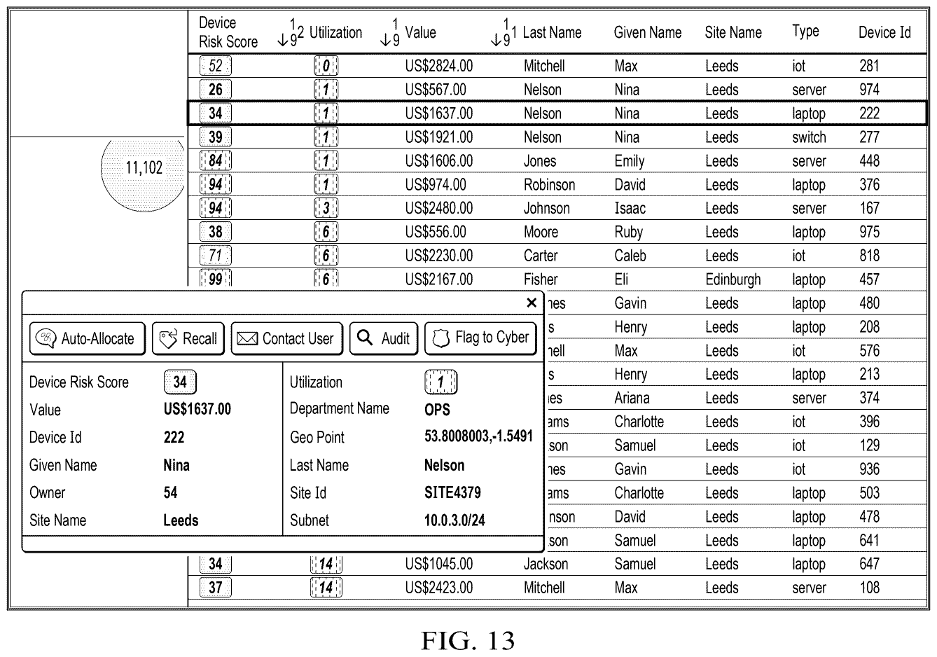

Data from the current set of data 274 can be modeled according to the data model definition 254 in a manner that may be easily utilized in a variety of use cases or scenarios in an efficient and up to date manner by dynamically constructing only those portions of a data model definition from that current data that may be explicitly requested or implicitly signaled. For example, an interface layer 214 may be implemented by embodiments using a user interface that may be a browser based or other type of interface that exposes a (e.g., user friendly) interface for user interaction such as for users to provide or request data or for the system to display data such as analytics (e.g., analytics). Portions of the data model may be explicitly requested or implicitly signaled or otherwise specified based on such an interface layer 214 or other components of the inventory data system 250. FIGS. 7-13 depict various embodiments of designs and visual implementations or interfaces of embodiments.

As discussed, defined data sources 210 can be associated with concepts in the first (least abstract) layer of the data model definition 254 representing the specific type or configuration of that data source 210. Thus, in some embodiments, a (current) materialized data model 294 maintained the inventory data system 250 may include data objects corresponding to the concepts of the first layer of the data model definition 254. A currently materialized data model 294 may thus be a data model that may be maintained and updated based on current data 274 or changes to the current data model definition 254 or may be maintained across different requests for data.

As discussed, as data is defined for, or received from, data sources 210 this data may be stored at the inventory data system 254 in the raw data store 138 as the current data 274. When data objects for concepts in other higher layers of the data model definition 254 are needed by the inventory data system 240, a working data model 296 may be generated. Specifically, desired higher tier concepts (e.g., any concepts that may be defined in any tier of the data model definition 254 that is higher than the first, least abstract, layer of that data model definition 254) may be specified by other components or subsystems of the inventory data system 254 such as search subsystems 230 or analytics platforms 220, or from other systems that interact with the inventory data system. For example, these higher tiered concepts 270 may be determined based on user requested data (e.g., a search or specification of certain concepts defined in a higher tier of the data model definition) or may be requested or specified by analytics or other types of applications that may make use of such higher tier concepts.

When such higher tier concepts 270 are determined (e.g., requested from, accessed at, etc.) by the inventory data system 250, a working data model 296 comprising data objects for those higher tier concepts can be (e.g., at least temporarily) materialized (e.g., in a volatile memory). To generate such a working data model 296, initially a working data model definition 298 may be determined. (e.g., comprising the concepts that will be included in the working data model 296). This working data model definition 298 may include a set of working data model concepts and a set of working data model transformations. These working data model concepts can be the set of concepts in the data model definition 254 that will be included in the working data model 296 that may be used to provide the desired higher tier concepts. Thus, these working data model concepts can include the determined higher tier concepts 270 and any concepts in any previous (less abstract) layers of the data model definition 254 on which those higher tier concepts depend (e.g., that may be needed to generate those higher tier concepts). Similarly, the working data model transformations may be the set of transformations of the data model definition 254 that are to be applied between concepts of the working data model definition 298 in one layer to generate concepts of the working data model definition 298 in a higher layer (e.g., that may be needed to generate the determined higher tier concepts 270 and any intervening concepts in different layers of the data model definition 254).

Thus, to determine working data model concepts and transformations, the transformations included in the data model definition 254 may be evaluated based on the determined higher tier concepts 270 (e.g., the requested higher tier concepts) to determine concepts of the first (lowest or least abstract) tier, and any intervening layers, of the data model definition 254 that may be required to generate those higher tier concepts. These transformations and any determined concepts of the first tier and any intervening layers may be included in the working data model definition 298.

In one embodiment, to determine the working model concepts, the determined higher tier concepts 270 may be added to the set of working model concepts in the working data model definition 298. Each higher tier concept 270 can then be evaluated to determine less abstract concepts in previous tiers of the data model definition 254 on which that higher tier concept depends. The less abstract concepts for a higher tier concept can be determined by evaluating the transformations between the tier of the data model definition 254 in which the higher tier concept resides and the previous tier (the previous or next least abstract layer) of the data model definition 254 to determine the previous layer concepts (e.g., the concepts in the previous tier) mapped to that higher tier concept. These determined previous layer concepts and the corresponding transformations can then be added to the working data model concepts and transformations of the working data model definition 298.

If the previous layer is not the first (least abstract) layer of the data model definition, the concept and transformation determination process can then be performed recursively on each of the determined previous layer concepts until concepts in the first (least abstract) layer of the data model definition 254 and their associated transformations are determined and added to the working data model concepts and transformations of the working data model definition 298. In other words, if the previous layer is not the first (least abstract) layer of the data model definition 254, each of the previous layer concepts can then be used as starting points to determine concepts in the next previous layer (less abstract) on which that previous layer concept depends and the associated transformations using the transformations between the previous layer and the next previous layer in the data model definition 254, and those next previous layer concepts and transformation added to the concepts and transformations of the working data model definition 298, and so on until the concepts of the first (least abstract) layer on which the higher tier concepts depends and their associated transformations have been added to the working data model definition 298.

Once the working data model definition 298 has been determined, to generate the working data model 296, the data objects of the currently materialized data model 294 corresponding to concepts of the first (least abstract) tier of the data model definition included in the working data model definition can be obtained from the materialized data model and added to the working data model. To determine the remainder of the working data model 296, current data 274 associated with these initial data objects added to the working data model 296 (data objects associated with the first (least abstract) tier) can be used to generate data objects for each of the working data model concepts in each of the higher level tiers of the working data mode definition 298 based on the source data of current data 274 associated with the initial data objects of the working data model 296.

Specifically, the transformations included in the working data model definition 298 can be applied to these initial data objects in the working data model 296 to generate data objects for concepts in the next highest tier of the data model included in the working data model definition 298. This process of applying transformations of the working data model definition 298 to the data objects of the working data model 296 is continued until data objects for all the working data model concepts included in the working data model definition 298 are generated and included in the working data model 296. This working data model 296 can then be utilized to provide data (or data objects) for concepts in the determined higher layers 270 of the data model 254 that may be needed by the inventory data system 250 (e.g., to perform analytics, provide a response to a request, return in response to a search, etc.).

It will be noted that while it may be desirable in some embodiments to create and materialize (and persist) a current data model 294, the creation and persistence of such a current data model 294 may not be necessary. In fact, all that may be required to generate a working data model 296 and working data model definition 298 may be a set of current data 274 and a data model definition 254. While embodiments have been described as including a materialized data model 294 (e.g., which may be stored in non-volatile memory or otherwise maintained or persisted in some manner) comprising data objects for concepts in the first (least abstract) tier of the data model definition 243 associated with data sources 210, such first tier data objects may also be generated dynamically from the current data model definition 254 and current data 274 at the time a working data model 296 is generated. Conversely, in some embodiments, it may be desired (e.g., for speed or efficiency reasons) to create and materialize a current data model 294 that includes data objects for concepts in tiers of the data model definition 254 other than the first (least abstract) tier of the data model definition (e.g., concepts in the first layer and the last layer of the data model definition). All such embodiments are fully contemplated herein.

Because a working data model 296 (and working data model definition 298) can be generated dynamically from a current data model definition 254 (e.g., only) when (e.g., certain determined) concepts in higher tiers of the data model definition 254 are required, changes to the data model definition 254 itself may generally be easily made without impacting any currently materialized data model 294 and without the need to re-generate any materialized data model 294 (e.g., because only concepts associated with data source 210 may be stored in a currently materialized data model 294, not those higher tier concepts),. Moreover, the concepts of the altered data model definition may be utilized substantially immediately by users or applications. As soon as the data model definition 254 is altered, this new version of the data model 254 will be utilized in generating working data model definitions 298 and working data models 296, taking any newly defined (or removed) concepts and transformations into account accordingly (e.g., without having to regenerate and materialized data model 294).

Additionally, the data structures and methodologies utilized by embodiments may be similarly utilized with respect to providing versions of the data model. Specifically, it has traditionally been the case that to store a version of a data model from a moment in time (e.g., an archived data model) it was necessary to persist the data objects of that version of the data model. In contrast, to allow embodiments of an inventory data system as disclosed herein to provide a data model associated with a specific time, embodiments may store snapshots 272 of data from various time periods. These snapshots 272 are just the state of the current data as it may exist at some point in time. Additionally, data model definition snapshots 288 may be stored for various points in time (e.g., any time the data model definition is altered). These data model definition snapshots 288 may be a data model definition 254 that existed at a point in time or for associated time intervals.

Thus, when a user desires a data model for a particular time, a version of the data model corresponding to that time may be dynamically generated by obtaining a data model definition snapshot 288 associated with a previous time closest to the particular time desired, obtaining the data snapshot 272 associated with a previous time closest to the particular time desired, and applying the transformations of the obtained data model definition snapshot 288 to the obtained data snapshot 288 dynamically generate the data for the particular desired time. Moreover, only certain portions of the data model for the particular time may be generated if desired. For example, a user or application can be presented with the ability to select or specify particular (e.g., higher level) concepts available in the data model definition snapshot 288 associated with the particular desired time. Once these selected or specified concepts are determined, only data objects for the data model associated with those selected or specified concepts (e.g., the specified or selected concepts along with any concepts necessary to generate those specified or selected concepts) need be dynamically generated to provide the selected or specified concepts for that particular desired time. These specified or selected concepts can, for example, be generated in a similar manner to a working data model, as described.

As such embodiments provide specific types of data structures (e.g., data model definitions including tiers of concepts and transformations that can be utilized to dynamically generate working data models or versions of a data model, including data objects for various tiers in a data model definition) designed to improve the way computing platforms, including inventory data system, store, generate or retrieve desired data. Accordingly, embodiments may dramatically reduce the computational and storage overhead associated with traditional approaches to generating and using data models. By avoiding the precomputation, persistence, and repeated versioning of data models, including unused or marginally relevant objects, embodiments may enable on-demand data interaction without requiring complete materialization of a data model. Moreover, by decoupling model construction from rigid preprocessing pipelines, a dynamic framework may seamlessly incorporate new data sources, respond to evolving data structures, and adapt in real time to shifting data use requirements. Embodiments may also obviate the need for storing redundant model snapshots by enabling reconstruction of temporal states without duplicating the entire model for each version. Collectively, these improvements may mitigate many of the inefficiencies and structural limitations that encumber conventional data modeling, thereby enabling fluid, scalable, and context-sensitive interaction with complex, rapidly changing data ecosystems. Moreover, embodiments may allow use cases for data to be specified (or data to otherwise interacted with by users or applications) based on the semantics of the data desired for use by an application and allowing the defined use cases to drive the management (e.g., indexing, including processing or semantic contextualization) of data.

Embodiments may thus harvest inventory data (data on an enterprise's estate) from various data sources (e.g., source of truth) from within an enterprise environment, such as ERP, SPM or CMDB systems. This harvested inventory data may be represented in a data model comprising objects defined according to a semantic data model definition (e.g., when such a data model or portions thereof are needed). This data model can be utilized to determine estate data (e.g., insights related to an enterprise's inventory data). Data determined at the inventory data system can be provided to a user or written back to the source systems such that it may be utilized by those source systems or users of the enterprise.

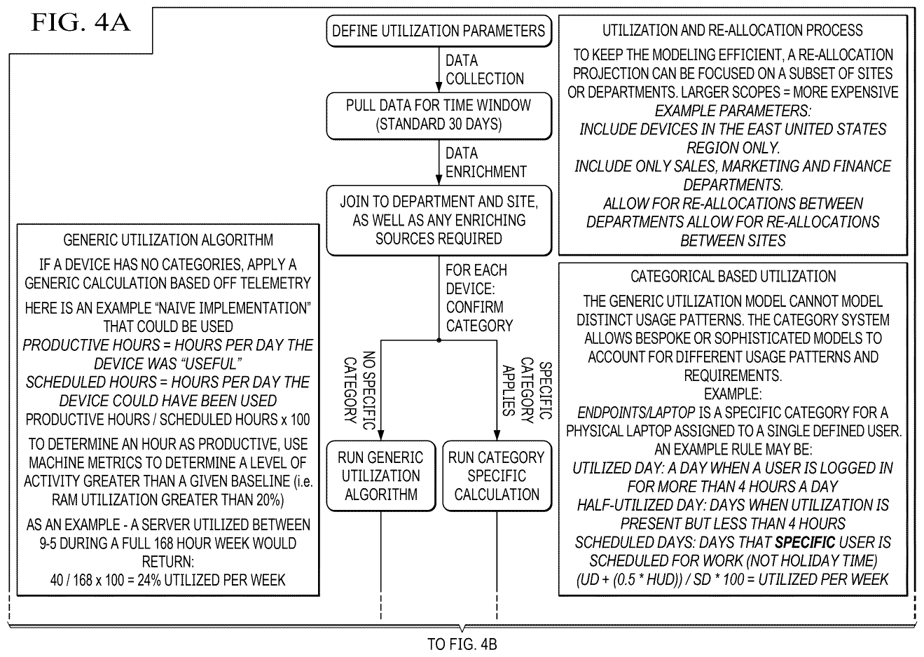

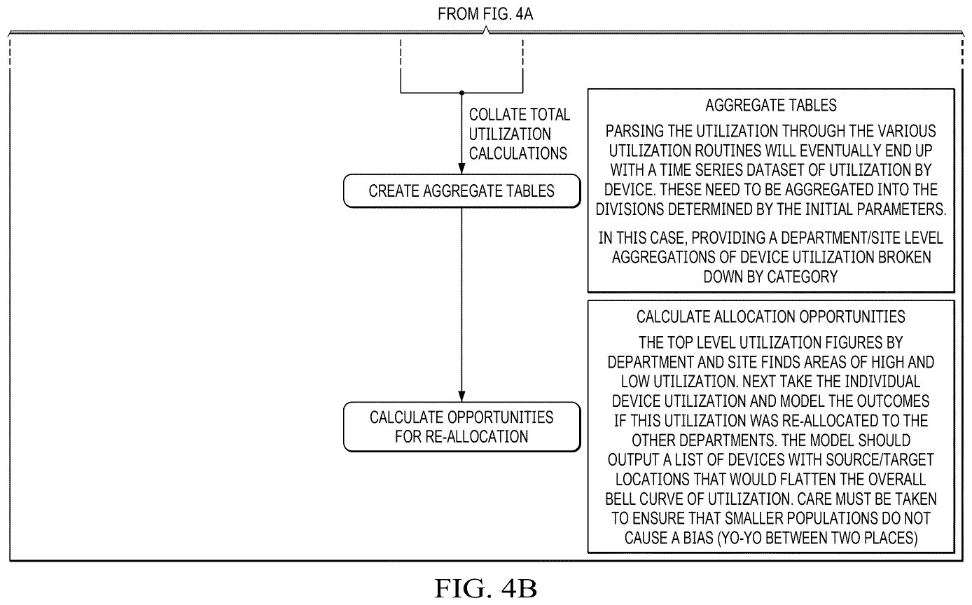

For example, embodiments may determine utilization data related to the quantity of usage for a device based on a specification of a device type with respect to definition of a data type (e.g., “network device”) in the semantic layer of a data model definition using data received from data source. One moment of such a global utilization method is specified in FIG. 4. This global utilization model may be adapted to model how much a device is being used—where that usage is a usage associated with aggregated usage of the device across the enterprise regardless of data source. This is because all data from all data sources across an enterprise can be associated with a data object in a semantic layer. This can be understood briefly with reference to FIG. 3j. Suppose a network device is specified by a user. The “network devices” object in the semantic layer of the data model that is associated with the specified network device can be generated based on each of the corresponding objects and data in the device layer 391 and the device abstract layer 393. This means that the “utilisation” field of that “network devices” object is determined based on applying the transformations 379, 377 beginning with source data associated with each associated object of the data model associated with the specified network device in the device layer 381 combining data for that specified network device from across the enterprise (e.g., enterprise level source objects 381, service management tool objects 383, cybersecurity monitoring tool objects 385, etc.)

As utilization has different meanings to different areas or contexts of the enterprise, embodiment of an inventory data system may present a holistic “usage” figure which is relevant to all areas of an enterprise. In some embodiments, the definition for a quantity of usage across an enterprise may be based on first taking the device type into account and broadly categorizing it (end user, mobile device, IOT, server, network etc.) and then allowing for sub categorizing information to be drawn from either the SPM or ITSM tooling (iPhone, Lenovo Laptop, SQL Server, MRI Machine). The categorization may then be utilized to determine how utilization should be calculated (e.g., to select an algorithm for determining usage quantity based on device type and other categories or data), since there may be different considerations per device type.

To illustrate in more detail, core computing infrastructure of an enterprise (e.g., switches, domain controllers, DNS servers, etc.) are expected to be present at all times, thus their utilization may be similar to traditional infrastructure monitoring in terms of capacity management. Each device's capacity should be reviewed individually, but the aggregate capacity per network site is more important. End user devices (e.g., smart phones, laptops, etc.) are expected to be used through most business hours, but aligned to exceptions during holiday periods. For these, embodiments may set an expected “usage hours” threshold combined with the device utilized metrics, to highlight where devices are being frequently underutilized.

Application infrastructure (e.g., servers, databases, cloud resources) are traditionally viewed on a device by device basis, here they are viewed in an aggregate view by application—since this accounts for DR hardware, extra capacity for extraneous events. In addition, environment specifications amend the end user tolerance. For production hardware it may be desirable to have capacity remaining, but in a development context it may not be desirable to tolerate waste). The utilization may initially be calculated on a time-series basis, to give a heatmap over time. However in this case a user interface may present a live “score” by department/site/application in order to consolidate the current utilization.

Embodiments may also be adapted to perform a number of detections based on data harvested from the source systems by evaluating objects in a semantic data model. Specifically, data objects (e.g., values for concepts in the semantic data model) can be evaluated or otherwise utilized based on a set of criteria or evaluated based on one or more models to perform detection. These detections of evaluations may be performed based on an initiation of such detections or at various intervals or based on triggering events based on such concepts.

In one case, these detections may include a network segmentation detection, where given a known network segmentation (e.g., subset of a computing network) an anomaly in the behavior (a new or unusual behavior) of the network may be detected using the data model according to the semantic data model definition. Another detection includes a rogue device detection where a device on the network not present in toolchains (e.g., as determined from SPM, ITSM, ERP data or a combination thereof) is detected and an action for security recommended or taken.

Another detection may be a shadow IT detection that tracks devices in ITSM or SPM but not in an ERP system meaning this (e.g., detected device) has not gone through full approval and governance, and should be brought into line. Missing devices may also be detected. These missing devices may be devices listed as “live” in an ERP/ITSM source system but not actively present or reporting. These devices could be lost or stolen. Such detections may be based on the object in the semantic layer by determining whether data is present in the device layer for different systems associated with that network device.

Embodiments may also employ location divergence detection whereby a device or user that has deviated from known or expected location or is presenting unusual behavior may be detected. High utilization detection may also be performed by an embodiment. This type of detection takes the utilisation concept or model (as discussed above) as a source and uses it to predict areas of unusually high utilization. This can be on a device level, application level or even a logical construct associated with an enterprise level (e.g., site of departmental level). Such a detection may provide a warning to an enterprise of potential capacity risk. Since this consolidates the view (e.g., a department or site view), this detection may highlight areas of resource conflict not visible within the silos.

Low utilization detection can also be performed. Specifically, embodiments may take the utilization concept or model as a source and use it to predict areas of unusually low utilization. This can be on a device level, application level or even some other logically defined level (e.g., by site or department). This detection provides a warning to the enterprise of potential waste. For example, an aggregate department or site view can highlight where silos are enforcing shared redundancies.

Optimization detection may be performed by embodiments. In this detection, the data included in the semantic data model may be utilized in association with existing detections and provides recommendations of improvements and arbitrage to improve aggregate performance. For example, if a single data center has multiple development workloads with low utilization each owned by a different department, this detection may recommend consolidation to improve overall efficiency. This can include devices in inventory stock not in current use—as long as the ERP can track inventory stock that has been purchased but not yet deployed. For example, a “$ optimization value” may result from calculating the amount of money that could be saved by consolidating hardware, reducing support costs etc.

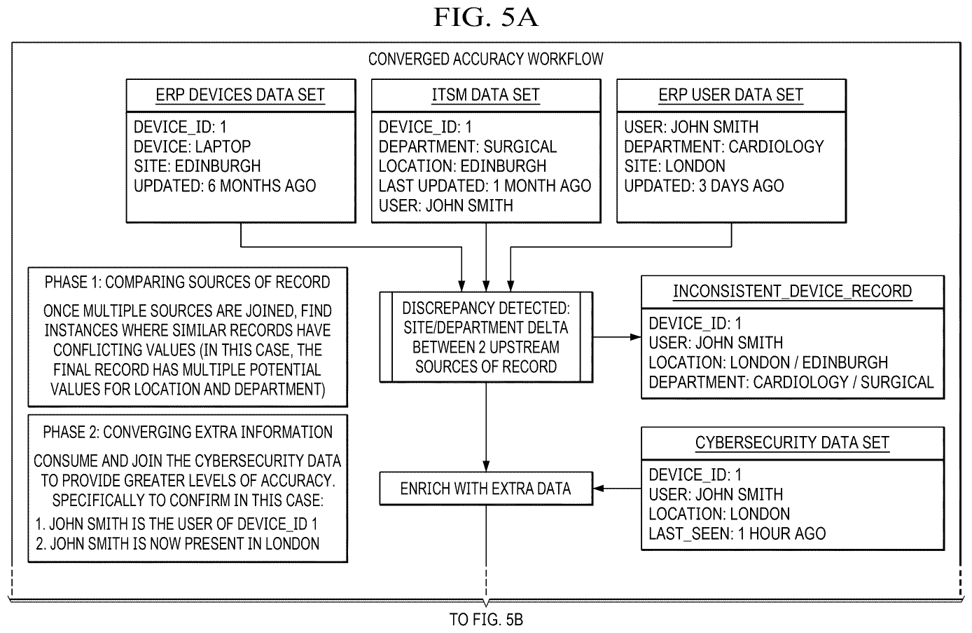

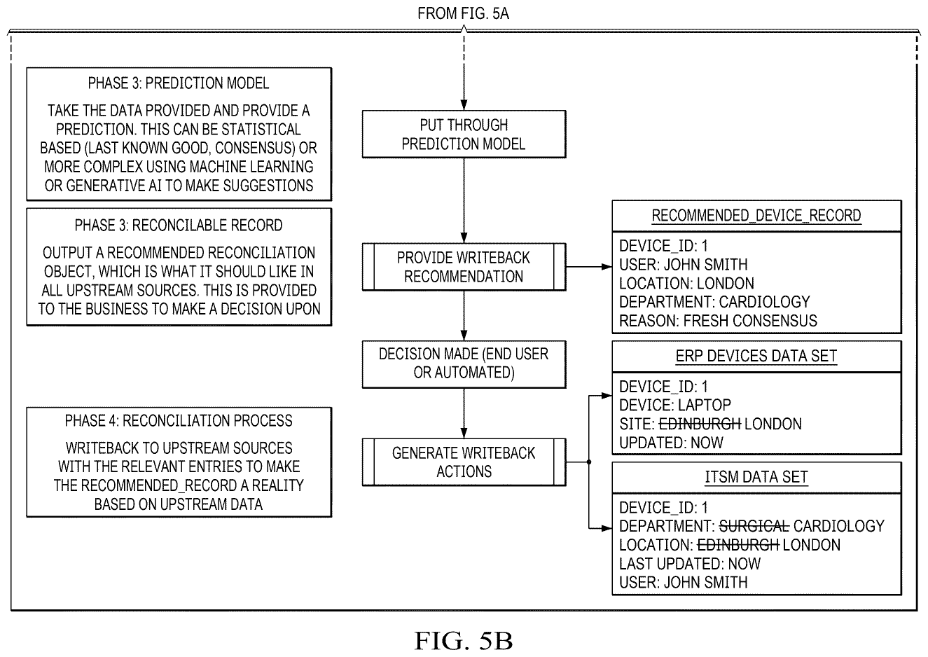

Converged accuracy detection may also be performed in certain embodiments. Embodiments of examples of methods of such converged accuracy detection are depicted in FIG. 5. In one embodiment a (e.g., first) use case of embodiments is to begin validating the correctness of the (agnostic or global utilization) model and processing the discovered accuracy detections. Detections may come with a recommended action based on various methods, and a user can choose to allow auto-remediation in bulk cases. Each detection may either be actioned upstream (a known delta) or will require the agnostic data model to be updated to reconcile the issue.

This detection may utilize a check against the data in the semantic data model to identify the same object within two upstream data sources, highlighting the conflict and providing a recommendation for resolution. This may be deterministic by time (last to update), by consensus (popular vote)—and can be improved using machine learning model recommendations and other methods. By comparing two systems of record and processing updates, the value of the tool may be exponentially improved by improving other processes not relying upon it directly as a source.

Allocation detection may also be performed using an inventory data system that models data according to embodiments of a semantic data model. be an identification where an upstream data source conflicts with inferences from other data sources. These inferences can be determined from different sources and will align to the semantic data model. This may be deterministic by time (last to update), by consensus (popular vote)—and can be improved using machine learning model recommendations and other methods. By comparing the systems of record against live data, embodiments may reduce the error rate and time to update of other business tools. This can include devices not yet deployed. For example, if Department X has 1,000 laptops in stock and Department Y needs 500 laptops, it is more efficient for the enterprise to reallocate that stock using an interdepartmental credit and deliver the value now, rather than allow each department to be responsible for their own logistics. The total value of “misallocated devices” is the sum total of the device values plus any current liabilities/support contracts associated. This “total value” may be incorrectly assigned in the source ERP system and thus ultimately represents inaccuracies in future budgeting and resource planning.

Embodiments may also perform licensing detection by correlating the software license contracts (e.g., licenses for certain software installations or otherwise, as determined from an ERP system) against the known assigned licenses (e.g., as determined from an ITSM system) and comparing that against the active used products (SPM). This allows for several license detections. A first type of licensing detection may be excess licenses assigned where the number of “active” licenses (ITSM assigned) and utilized (actual usage in a last period of time) is such that there are licenses assigned that are not being effectively used. This should be forwarded to the user and possibly a user designated as management to evaluate if the license is actually required.

Excess licenses purchased can also be detected. This detection may be a number of purchased licenses and the number of used/assigned licenses is such that the company has a surplus over their modelled preferences. If there is a renewal date coming up, an alert may be created based on this detection to a certain user of the enterprise (e.g., associated with a purchasing department) along with a recommendation based on actual utilization.

License utilization anomalies within the enterprise can also be detected by embodiments of an inventory data system. Such a detection may be performed when the number of license assignments or license utilization has changed unusually recently. This could indicate changing behaviors or operational risks. Another detection that may be performed is an unlicensed activity detection. This detection may detect software known to require a license is in use in the estate of the enterprise without ERP or ITSM record, or the number of licenses used exceeds the known count. This is an operational and legal risk and should be remediated quickly to avoid fines (if it's an audit issue) or outages (if license excess breaks a service). Embodiments may also detect licenses that are on the verge of expiring and provide a license expiry warning: If a license is due to expire in ERP in the near future and there is still service level utilization, this is an operational risk as processes may be affected if the license to operate expires.

Embodiments may also leverage the semantic data model or the utilization model to provide cross-departmental (or any other logical division of an enterprise) purchasing consolidation. To illustrate, most purchasing in an enterprise works on a departmental basis (e.g., based on some logical division of an enterprise). Each department (or other logical division) is responsible for raising their own orders with a central team. By taking a holistic approach to inventory of enterprises, embodiment can provide multiple recommendations.

These recommendations may include a purchasing consolidation. If there are multiple departments requesting the same device, it may be more logical to combine the order with the vendor in order to take advantage of a bulk discount. Predictive ordering-by understanding current utilization trends in the enterprise, embodiments can detect which devices will be needed in the near future, allowing for central purchasing to order ahead of time when the cost of purchase is most efficient. Another detection may relate to order avoidance. By understanding the current estate in its entirety, embodiments may provide recommendations to eliminate a purchase by reallocation of a device to another department. End of life detection may also be performed.

Embodiments may consolidate the utilization, support contract or overall value of a device allowing a determination to be made about when a specific piece of hardware is no longer fit for purposes due to being end of life. As such, it may be the target of an optimization workflow to either replace it or consolidate the workload elsewhere.

It may be useful to discuss using semantic data models according to embodiments to determine utilization or converged accuracy in more detail. As discussed, embodiments of the systems and methods can perform utilization categorization. Utilization may heavily rely on the categorization theory of understanding what device types are because the way embodiments of the systems and methods want to treat any particular device will differ in terms of utilization depending on its use case and function. To achieve this utilization embodiments will use fresh live data. So this will give embodiments data such as length of time users have been logged in for certain service utilization at the infrastructure layer (e.g., for example, CPU, RAM, network bandwidth). Embodiments will also get utilization such as on processes being run or on items such as messages, utilization, function calls, etc. In order to get utilization data that is of relevance, embodiments may need (in one embodiment) around 30 days utilization data and realistically the longer the data store the better quality and better accuracy this will be.

One step may be to determine how embodiments of the systems and methods are going to qualify the baseline utilization percentage, which is partially based on the categorization theory. But in a general utilization theory, embodiments of the systems and methods simply make a naive set of implementation metrics that tell us is the thing being used, and if so, for how long over a period of time. This may be essentially the potential hours of utilization versus the actual amount of time utilized per sentence and embodiments. Embodiments may choose to include or exclude business days or working days or holidays depending on use case. This is where the modelling categorization may be utilized. Because if embodiments of the systems and methods take the naive approach to every device, embodiments of the systems and methods may obtain a very skewed picture. The functional importance of this, though, is not any one model or not any one algorithm. It is the principle of being able to do so. It is the principle of building app models that more accurately reflect the category types rather than any specific category, as an example, end user devices versus hardware devices that sit in the data center. Embodiments can go further than categorization theory and may be enterprise use case specific and embodiments allow them to do so.

Once embodiments have bucketed and calculated this utilization theory per device, the next step is to do the determination itself. Once this data has been calculated for a bucket window, it may not need to be repeated because embodiments of the systems and methods may be able to calculate the utilization bucket once and store it (e.g., and cache it). For that storing or caching to be effective though, embodiments may be clear on two things: the categorization methodology that embodiments are using for the device type and the bucket window at which embodiments are calculating embodiments are determining percentages.

From an algorithmic perspective, it makes may make little difference whether embodiments of the systems and methods calculate utilization percent over the, for example, last 30 days or utilization over the, for example, last day or last hour, but from a computing resource perspective though, it makes a very large difference as the amount of data involved in the two scenarios may be huge, For example, determining the number of buckets will change the cost profile of the job to run an equally will reflect on the granularity and accuracy of the data. This therefore becomes a question of risk vs. reward. Embodiments of the systems and methods may probably start with a higher level of granularity to show initial pay off and then doing lower levels of granularity on specific categories of devices where it's deemed desirable or necessary and required.

It's also useful at this point to remember that there are some devices embodiments will never want to question the utilization of. For example, if embodiments have a regulatory requirement for three sites and a certain device exists in each site, then it's rather irrelevant how heavily utilized it is. So therefore, embodiments may wish to exclude this device from the calculations entirely. And this (e.g., exclusion) could be done as part of the categorization in type theory. The end result of this process may be the average utilization of devices by bucket by time. This will give embodiments a large amount of numbers. The data can then feed into the semantic data model.

Accordingly, embodiments may have a device level view (e.g., which is the average utilization) that is achievable at an enterprise level perspective (e.g., by department) that is not currently achievable at least because the existing tool chains only track device level so far up the enterprise hierarchy. In contrast, embodiments may use the semantic data model to reach that level of enterprise abstraction.

At this point, embodiments of the systems and methods now have an semantic data model that is populated and can be used to detect the exact utilization or the average utilization of various devices across the estate. This capability allows embodiments to make some allocation decisions that hitherto may not have been possible. This can be done at a granular level (e.g., a device type). For example, a specific SKU of an MRI machine as an example, such as when a hospital uses a specific MRI machine and needs to know their current utilization because it's expensive and there's a backlog. Understanding exactly how many MRI machines are available across the hospital or set of hospitals and their location may be important as it allows the hospital or embodiments to determine data associated with these devices that perhaps may not be available to the individual users at the hospital or individual departments around these machines.

Embodiments of the systems and methods can then start determining data related to obtaining more devices, moving devices, reassigning devices, etc. This data may be determined by looking at the deltas of the utilization associated with device types (e.g., devices broken down by the semantic data model type that embodiments wish to analyze). Embodiments then look at the percentile differences at the edges, and what embodiments will likely find is that there are areas having very high utilization, areas that have capacity requirements and areas of low utilization.

Once embodiments have identified specific categories (e.g., departments or sites that have a surfeit and specific departments that have a deficit) embodiments can go into some modeling to understand where reallocation may be optimal. For example, there are 10 development application servers in department A currently running below 20% utilization. There is a production server application in department B that is running at 98% capacity and has done so consistently for the last 30 days that is at serious risk of resilience. The production team in department B have raised a purchase order for 10 more servers. Embodiments of the systems and methods can be determined there's a utilization deficit and a surplus, and embodiments of the systems and methods can model and suggest that embodiments of the systems and methods do some quick migrations of the servers across the department and rebalance capacity to make optimum use of resources. The modeling of this may be done using overfitting.

However, if embodiments of the systems and methods do this at the device level first and then at the department and then at the site, embodiments of the systems and methods can suggest some optimal improvements. The achievement of this can be done with statistics or with advanced modeling including machine learning models. This will allow embodiments to identify the potential cost differential (e.g., how much resources are saved by moving devices versus paying for new devices). So for example, if a device is moved from site A to site B, then an enterprise has not paid for a new server. Therefore, the saving I've made is the cost of that new server plus the cost of that support contract plus the cost or the purchasing, or the time to set it up.

There's also the potential mismatch cost. The mismatch cost is where a cost was allocated to department A or site A, and convergent accuracy has detected it may be allocated to department B or site B. While this is technically no change to the enterprise in terms of financial implication, it will have a change of future and budget allocation. The assumption is that every department's budget will partially be based on what they currently have, an asset or what their current assets and liabilities are. If the source of record that this is being calculated upon is incorrect, then those budgets will be incorrect. Therefore, embodiments of the systems and methods can calculate the cost value or the potential value of these devices that embodiments of the systems and methods have detected as incorrect, and surface that data as the misallocated funds cost the enterprise could be saving by using this kind of methodology. The reason for surfacing this cost is to highlight to the enterprise that inaccurate data does cause cost and improve their position if the data is remediated.

Embodiments of the systems and methods may now have the ability to highlight devices that are underutilized or overutilized. Embodiments can break down any device by department and embodiments of the systems and methods can use the semantic data model to take a data point from any source system and conjoin it with the data point from another source system and find accuracies and gaps. Embodiments of the systems and methods can then allow the write back to those source systems. By essentially surfacing those detections of differences and allowing the user to select which one of these may be the correct option embodiments of the systems and methods can use phrasing (e.g., across systems) and terminology, etc. that will fit neatly into the agnostic data as embodiments have reconciled these data before.

Embodiments of the systems and methods can then use this aggregate data to provide better posture management risk scores to allow embodiments to look at the risks for individual devices and utilization. By joining the device level data to the ITSM data embodiments of the systems and methods can now do risk scoring profiles by application. So IT service management tends to treat collections of applications or individual applications of a service. Being able to break down the posture of an application as opposed to a server while it is at a higher level risk may make data a lot clearer to the enterprise in terms of the potential risk profile and the appetite for remediation.

Traditionally, some of the most profitable systems are the least secure. If embodiments of the systems and methods look at financial IT, there are many, many safe systems of venerable age. Adding up the total risk and breaking that by department will make those decisions clearer to an enterprise. Embodiments of the systems and methods can also break it down by utilization tier. So depending on how the IT teams are organized, embodiments of the systems and methods can break down not just by which application has the risk, but also which team it is. Since cybersecurity data is already pulling in state change, such as processes running, embodiments of the systems and methods can also align this with CVES or exploits. Embodiments of the systems and methods can also start to feed in and use vulnerability management data to give a more accurate and concrete and fresh risk score so as vulnerabilities emerge embodiments can highlight these vulnerabilities with respect to individual devices, departments, applications, etc.

Since embodiments of the systems and methods also have the network telemetry by device, embodiments of the systems and methods can also graph how an enterprise's estate fits together. So embodiments of the systems and methods can now take all of that data and can check that against the network telemetry to understand which of their nodes are talking to other nodes. Embodiments of the systems and methods can go beyond the lower level network telemetry. A traditional network graph may show us IP addresses joined to IP addresses. Embodiment may go beyond that to allow users to understand which application, Environment, Department, locations, etc., are communicating with one another. This type of graph allows embodiments to discover potential toxic combinations. For example, if an enterprise has a particular node that all data is running through that is a clear single point of failure which may need to be dealt with at an engineering level.

Engineering this graph as a technical implementation is walking the graph comprising the nodes corresponding to data from the source systems mapped in the semantic data model or associated data maintained in association with the semantic data model. Embodiments take the network data and find all the possible nodes where communications happen. This can be done, for example, using DNS logs, Netflow, DHCP, proxies, firewalls, etc. Once embodiments know communication pathways, embodiments have a graph of objects of nodes that are communication (e.g., at a device level). This graph can be correlated or fed into the agnostic model

And at that point embodiments can then bubble up. Embodiments can use the semantic data model to join that to the device and then use that to join that to the application ID and then use that to join that to the business entity ID. And so embodiments can then identify for each IP address, which server that was, which application that was and department that was. Again, embodiments of the systems and methods do not need (in one embodiment) the granular data. Embodiments of the systems and methods simply may show the distinct departments, environment, etc. along with any desired. Embodiments also then have network data statistics. (e.g., devices that have talked to a device, number of devices I have talked to) or other statistics.

Once this data has been stored as part of the semantic data model, the modelling of it simply requires embodiments to select characteristics that it is desired to filter by. In the same way that embodiments of the systems and methods walk the graph backwards to do writeback, embodiments of the systems and methods right walk the graph outwards to find all of the nodes that are relevant.

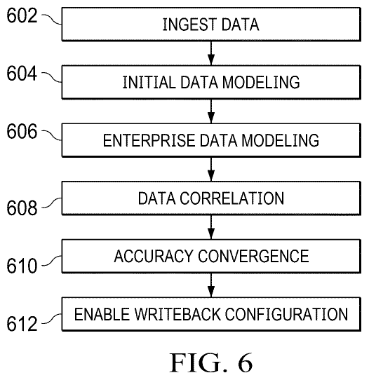

FIG. 6 depicts one embodiment of a method for modeling data according to a semantic data model, including determining a semantic data model definition and use of semantic data models according to that definition. As can be seen, embodiments may perform data collection where data is ingested from various source systems (STEP 602). The more upstream data sources there are, the larger the benefit an enterprise will see. In embodiments, these source systems may include ERP, ITSM or SPM source systems. Data collection may also include the onboarding, or collection from, any cybersecurity monitoring tools or system within the enterprise. Data collection from source systems can be done based on a schedule or streaming of events or on demand (e.g., through an API or the like). Connection to these source systems may be automated and not require manual credential admission. In one embodiment, at least on ERP, at least one ITSM, and at least one source of security posture management are included in the data sources.

The data collected from the various source systems and stored in the columnar formats may be utilized for initial data modelling (STEP 604). Here, the data feeds are aligned to the core semantic data model definition. The model definition acts as both the central view of the data and also acts as a reference model (e.g., table), since it allows cross-referencing at (and to) the underlying data model itself. This base data modeling may perform a mapping of the multiple source fields of each of the source systems data to the key concepts (e.g.,. fields) of the semantic data model definition Note then, that according to embodiments that semantic data model definition may act as the core “upper layer”, covering sufficient detail only to allow for joining objects for the lower levels of the data model definition (e.g., the data as determined from the source data systems) together.

As a next step, client or enterprise data modelling can occur (STEP 606). The core data model provides the core “target states” for the holistic inventory. Many enterprises may desire to create some ancillary lookup tables that provide their own static data which also fits the model. This is especially true for sites, an object that may not be accurately modelled in their existing toolchain. Data correlation can then be performed (STEP 608). Here, the variously modeled feeds (e.g., from the source systems) are now correlated against one another to determine an initial view. This can be achieved by joining the various tables together, using the semantic data model definition as the cross-reference.

In such an initial stage mapping relevant field names of the source data systems are aligned to the semantic data model definition. As discussed the semantic data model definition may be deliberately high level and abstract, and will avoid concrete instantiations of most areas. A good example of this may be for a site (e.g., physical place). Embodiments of the systems and methods may know only sufficient information to locate it in its geometric location where it is in the world, and embodiments of the systems and methods need (in one embodiment) sufficient information about it to identify it and distinguish it from another site. Another example is people. Embodiments of the systems and methods may know enough to identify a user based on their unique identifier in the various systems, downstream and upstream, and embodiments of the systems and methods also may understand enough about them to identify them in a timely manner. Another example is a device. A device may have all sorts of metadata depending on the upstream systems. Such as its owner, functionality, MAC address, etc. Some of this is irrelevant to the semantic data model and may not be mapped at all. Some of these column names will be very different (e.g., than their source systems), but will coalesce to a single understanding in a single object in a higher layer. So for each system of record (source system) there may be a unique identifier. These may be correlated together and kept in that same object. This may facilitate data mapping by embodiments of the systems and methods.

Similarly, if there are two or three fields with different names in different source systems, they may all be mapped to a single (or multiple) concepts (fields) in the semantic data model and the transformation stored. So, for example, embodiments of the systems and methods will have a unique ID per device per user. And embodiments of the systems and methods will have sufficient information to do cross domain lookups. So if, for example, embodiments of the systems and methods have an SAP reference and a ServiceNow reference or a single object such as a server, embodiments of the systems and methods may from the semantic data model be able to find that server. Take those two IDs and join across the two data sources to find information from both fields.

The action taken after creating that top level model is creating or displaying the cross joined tables. This may be the ability to take a single data source or data point, from the semantic data model and show all fields from all systems at the point in time. Now, in order to do this, the individual column names may need (in one embodiment) renaming to identify their source system (e.g., because there will be clashes).

As but one example, in a name field most tools will not allow embodiments to show the same field (e.g., the same name cannot appear in two columns). Embodiments of the systems and methods may prefix a (e.g., duplicate) name with the name of the source system. So instead of displaying (just a) name, embodiments may display a ServiceNow name or embodiments may display SAP name. This gives embodiments a very wide view because the length or the width of that table will be the width of the columns per system times the number of systems. This will give embodiments the picture of conceivable viewpoints on (e.g., almost) every conceivable device item.

The next step is the deduplication and the convergence of accuracy (STEP 610). Here, embodiments of the systems and methods can identify pairs or triplets (or more) of fields across (e.g., source) systems which fundamentally return the same thing. Similarly, embodiments of the systems and methods can identify where there is a distinction or a difference. At a simple and naive implementation, for example, embodiments of the systems and methods can check the environment field (e.g., does it stay or include the same data) (e.g., development or production).

At an even more simplistic level embodiments of the systems and methods may check to determine if a device is in the same location (e.g., country) because most devices have location. Now what will happen is that systems have been updated manually where they have been purchased from one location and then moved (it is very common to find incorrectly addressed locations in such in that). This situation will cause inaccuracies in reporting and this is what embodiments may process the data to determine. So embodiments of the systems and methods can cross join data on for example a location field (e.g., country field where embodiments of the systems and methods find all country fields may be the same (e.g., coalesce to the same value). Then embodiments of the systems and methods can mark that as consistent.

Where embodiments find there are multiple values that have the same semantic definition but different values, embodiments of the systems and methods may mark them as inconsistent. And so embodiments of the systems and methods will end up with a subset of the core records which are inconsistent in value type. This is where embodiments of the systems and methods may test (e.g., using various modelling techniques) to understand what are the correct answers or data. Again, a simplistic answer might be consensus: where there is more than one result for one particular answer and only one result for another. For example, multiple source systems may have data indicating a device is in the United States, and one system indicates the device is in Turkey. A consensus may be that it be marked as the United States.

However, embodiments of the systems and methods have more assets at our disposal than simple consensus because consensus requires sufficient data sources to form a quorum. Embodiments of the systems and methods can also use freshest in time, so a data point that is relatively recent is more likely to be up to date (e.g., than an older data point) Embodiments of the systems and methods can use accuracy of source. Say for example a reporting tool from the device itself (e.g., a device with GPS that is literally given as a geopositional data point in the last hour is probably more up to date than something that was manually inputted 6 months ago.

Embodiments of the systems and methods can also use a number of data points and trust that embodiments of the systems and methods can build ever more complex models to make this decision. However, the advantage is that once embodiments of the systems and methods compare these sources of record, embodiments of the systems and methods can come up with the correct answer and then provide that recommendation along with our rationale to an end user for them to make the content. If the end user becomes confident enough in the modeling of embodiments, embodiments of the systems and methods can then automate those decisions (e.g., without express user involvement). Due to the complexities of the upstream systems as part of the columnar mapping process where embodiments of the systems and methods already mapped which columns relate to another in the core model, embodiments of the systems and methods may explicitly mark which of these fields embodiments of the systems and methods wish to modify for convergence and accuracy and to what level. It will be understood, with reference to embodiments as disclosed, however, that the details of that modelling process are infinitely extensible.

Embodiments of the systems and methods can also add extra value (e.g., to the semantic data model) from cyber security data. The cyber security data is the core platform used by embodiments. This is what takes the large volumes of up to date telemetry and converts it into semantic value. For the purposes of a data model, embodiments of the systems and methods are not often interested in the individual events. The individual events may be, for example, for a security purpose. Embodiments of the systems and methods may be more concerned about change of state. The primary state changes embodiments of the systems and methods care about for an inventory perspective may be change of locale (e.g., where the device was in one place and is now in a different one); change in identity or user ID (e.g., when someone else uses a device that has never used it before); and change of operating procedures (e.g., where something such as a device or user is doing something it had not done previously, such as different type of activity, utilization, or processing).

Writeback configuration may also be enabled (STEP 612). For every upstream data source that will support writeback (e.g., supporting converged accuracy), a connection will be created with the respective source system to allow this and any mapping fields to be aligned. Writeback to upstream sources may be configured for every data source that needs bidirectional capability by obtaining connection information (e.g., host, credentials, list of tables under management, whether it's an API or direct database connectivity, etc.) for those data sources. The mappings between the semantic data model and the source system may thus be determined or utilized. These mappings may include the concept (e.g., field or column) mappings but also any data specific requirements where there are different validation requirements. As part of embodiments, the system may also be configuring write back credentials. So for every system of record (source system) embodiments are adapted to keep updated, the system may ensure the system has the service credential that has the ability to write to the relevant tables or APIs or that source system. In some embodiments, the ability to make API calls or other interfaces (e.g., of source systems) may be farmed out to other multiple systems once bidirectional connectivity has been established. In particular, it may be possible to farm out bulk updates to multiple disparate systems based on a single update. The data can then be refreshed and re-processed, ensuring the update has propagated throughout the systems or platforms of embodiments.

Embodiments may include events as provided in association with a device or user. The purpose of some embodiments, and what embodiments of the systems and methods may do is that as those events are processed from every device, if there is a state change and then a coalesced entity table may be updated with the relevant record. Because embodiments may not be concerned with every event line by line. Embodiments of the systems and methods may see just the latest state of any entity as well as the state changes over time.

So as embodiments of the systems and methods make those changes to the data model, embodiments of the systems and methods may be able to wind the semantic data model for an entity back to audit it and see the previous history, the previous state of the entity, and at what time those states changed. This is what gives embodiments the ability to give an up to date moving picture of the life cycle of a device.

Now embodiments of the systems and methods may be able to do the same actions and the same recording with the standard data source such as SAP, ServiceNow, et cetera. The key difference between that and the cyber security telemetry as used by embodiments, is that the telemetry is live and fresh and will have the most frequent change (e.g., certainly in terms of aggregate volume). On an individual device level, embodiments of the systems and methods may not perhaps expect to see great change, but over the estate wide view (especially when embodiments get to hundreds or millions of devices), embodiments will see a much more frequent change pattern.

These aggregate state changes may be utilized, for example, in an orchestrator. The orchestrator may not consume all the events and attempt to do any work upon all those events, because that may be inefficient and very expensive. And that's the purpose of dividing the workload between the classic slow moving inventory tooling, which can fit into relatively small dimensions, and the cybersecurity life telemetry which usually cannot. That slice of state machine that can be added to the converged accuracy of the upstream data sources, and that is what will give embodiments a next layer of converged accuracy. Rather than comparing source of record to source of record embodiments of the systems and methods are now comparing source of record to truth from the ground truth.

In certain cases, the ground truth perspective is too granular. As an example, an employee's laptop will be marked as being owned by a user, and of course the laptop might be listed as being registered as an office (or at home). The reality is that the laptop might be used in Costa Coffee up the road or might be taken on the road to Leeds to see another office. In such scenarios, this is where the categorization of the future modelling state becomes important.

So once embodiments of the systems and methods when embodiments of the systems and methods are comparing sort of record to ground truth. Embodiments of the systems and methods may consider the lower level modelling categories. At a simplistic level, this means that embodiments of the systems and methods can compare types of devices in different ways or one another. For example, simply using taggings or hard coded categories can be exponentially improved with more data sources. In certain cases, for example, once embodiments have added ITSM data, embodiments can make analogies based on department or environment.

Once embodiments have added embodiments to cloud security posture management tooling, embodiments may choose to only introspect devices of a certain security risk, or hire, or perhaps once embodiments have added SAP data, embodiments may wish to be more granular or treat with more accuracy those devices deemed critical to the business. The analysis of this tag based comparison, which may be the second stage of converged accuracy, will allow the enterprise to ensure that their sources of records reflect the truth on the ground.

Once this process has been completed initially, changes in the upstream sources of record (source systems) may be much more frequent and much more accurate. This of course means embodiments may trigger a writeback. To do this, embodiments select all of the columns that match (e.g., inaccurate) criteria). Say for example, if embodiments determine that fields are marked as development and should be productions, once embodiments of the systems and methods have identified the record IDs that may be amended in the fields, embodiments of the systems and methods then may walk the graph.

Specifically, embodiments of the systems and methods may determine from the semantic data model which sources of record (source systems) data comes from, and embodiments of the systems and methods know from the semantic data model which field mappings and source systems they go back to. So for example, embodiments of the systems and methods know that SAP calls this field 92 called “entity” and embodiments of the systems and methods know that in ServiceNow Field 76 is called “department” and both these fields resolve back to an semantic data model field called department. So the write back is to go back to each source system, correct the field name to the one from the source system, and take the correctly matched value and then write that value. This fan out pattern means that the more data source embodiments have mapped, the greater an impact a fan out will be. So if embodiments have ten sources of record, an update may affect up to ten sources downstream or upstream.

Once embodiments of the systems and methods have added convergent accuracy with our cybersecurity data, embodiments of the systems and methods now have our semantic data model with all the sources of data upstream fully mapped and writeback enabled. Moreover, embodiments are receiving a mutating state from the live data from the source systems giving (e.g., frequent) updates. Embodiments of the systems and methods can analyze allocation accuracy. Allocation accuracy is an extension of convergence accuracy, which is to try and understand whether the upstream sources of record (source systems) are not just accurate in terms of truth, but accurate in terms of the enterprise.

So once embodiments of the systems and methods move away from the simpler, the hard objectives of user and location, embodiments of the systems and methods can now move on to things like enterprise and department. Because business and department and usage are slightly less concrete, embodiments of the systems and methods need (in one embodiment) more upstream data sources in order to correctly achieve this or to gain corrective accuracy. The more data sources embodiments of the systems and methods have, the more likely this accuracy is going to be.

Embodiments of the systems and methods embodiments of the systems and methods break up devices by field in terms of their current user current owner and determine distinct patterns of difference for example. If all of one department is in a single office and yet three of the devices are listed in a different office and no users in that office have that presence then it's highly unlikely that this is accurate. Either there are some employees that may be based in that office, (which embodiments of the systems and methods may have found in our first round of convergent accuracy in terms of staffing) or a device is correctly allocated to a person but incorrectly to a site, and this can then be reallocated and reassigned. This allocation accuracy is largely fulfilled by joining devices at the IT service layer, which links things to the (e.g., SAP) data which links businesses to people.

Embodiments as described herein or otherwise may also be understood with reference to the specification (including the drawings) and the claims. Those skilled in the relevant art will appreciate that the invention can be implemented or practiced with other computer system configurations including, without limitation, multi-processor systems, network devices, mini-computers, mainframe computers, data processors, and the like. Embodiments can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines. Examples of a non-transitory computer readable medium are provided below in this disclosure.

Although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a set of distributed computers communicatively coupled to a network (for example, the Internet). Any suitable programming language can be used to implement the routines, methods or programs of embodiments of the invention described herein, including R, Python, C, C++, Java, JavaScript, HTML, or any other programming or scripting code, etc. Other software/hardware/network architectures may be used. Communications between computers implementing embodiments can be accomplished using any electronic, optical, radio frequency signals, or other suitable methods and tools of communication in compliance with known network protocols.

Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such a computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

What is claimed is:

1. A method for data modeling, comprising:
storing raw data received from one or more data sources at a data management system, wherein raw data from the one or more data sources is received according to different data schemas;
determining a requested concept defined in a semantic layer of a data model definition, wherein:
the data model definition includes multiple layers of concepts, and transformations between each of the multiple layers of concepts,
the multiple layers include a first layer comprising a device layer and a second layer comprising the semantic layer,
the transformations define a derivation for generation of data for concepts in a more abstract layer of the multiple layers from concepts in a less abstract layer of the data model definition;
generating a working data model comprising first data objects for the requested concept by:
determining second concepts of the first tier based on the requested concept by evaluating transformations of the data model definition associated with the requested concept, the second concepts associated with data sources providing data associated with the requested concept;
obtaining second data objects associated with the second concepts, the second data objects associated with raw data received from the data sources providing data associated with the requested concept;
adding the second data objects to the working data model;
applying transformations of the data model definition associated with the requested concept to the second data objects associated with raw data received from the data sources to generate the first data objects associated with the requested concept; and
adding the first data objects to the working data model; and
providing the working data model including the requested concept.

2. The method of claim 1, wherein the working data model is dynamically generated in response to the determination of the requested concept.

3. The method of claim 1, wherein the second data objects are obtained from a previously materialized data model.

4. The method of claim 1, wherein the data sources include a Security Posture Management (SPM) system, a Configuration Management Databases (CMDB) system of an Enterprise Resource Planning (ERP) system.

5. The method of claim 1, wherein the semantic layer includes a foundation layer, an authoritative layer, a reporting semantic layer, a detection layer, or a presentation layer.

6. The method of claim 1, further comprising:
storing a data model definition snapshot associated with a time;
storing a data snapshot of raw data associated with the time; and
In response to a request, generating a version of the data model associated with the time by applying the data model definition snapshot to the snapshot of raw data for the time.

7. The method of claim 1, wherein the request specifies a concept associated with the data model definition snapshot and the version of the data model definition only includes data objects associated with that specified concept.

8. A data modeling system, comprising:
a data store storing raw data received from one or more data sources, wherein raw data from the one or more data sources is received according to different data schemas;
a processor; and
a non-transitory computer readable medium, comprising instructions for:
determining a requested concept defined in a semantic layer of a data model definition, wherein:
the data model definition includes multiple layers of concepts, and transformations between each of the multiple layers of concepts,
the multiple layers include a first layer comprising a device layer and a second layer comprising the semantic layer,
the transformations define a derivation for generation of data for concepts in a more abstract layer of the multiple layers from concepts in a less abstract layer of the data model definition;
generating a working data model comprising first data objects for the requested concept by:
determining second concepts of the first tier based on the requested concept by evaluating transformations of the data model definition associated with the requested concept, the second concepts associated with data sources providing data associated with the requested concept;
obtaining second data objects associated with the second concepts, the second data objects associated with raw data received from the data sources providing data associated with the requested concept;
adding the second data objects to the working data model;
applying transformations of the data model definition associated with the requested concept to the second data objects associated with raw data received from the data sources to generate the first data objects associated with the requested concept; and
adding the first data objects to the working data model; and
providing the working data model including the requested concept.

9. The data modeling system of claim 8, wherein the working data model is dynamically generated in response to the determination of the requested concept.

10. The data modeling system of claim 8, wherein the second data objects are obtained from a previously materialized data model.

11. The data modeling system of claim 8, wherein the data sources include a Security Posture Management (SPM) system, a Configuration Management Databases (CMDB) system of an Enterprise Resource Planning (ERP) system.

12. The data modeling system of claim 8, wherein the semantic layer includes a foundation layer, an authoritative layer, a reporting semantic layer, a detection layer, or a presentation layer.

13. The data modeling system of claim 8, where the instructions are further for:
storing a data model definition snapshot associated with a time;
storing a data snapshot of raw data associated with the time; and
In response to a request, generating a version of the data model associated with the time by applying the data model definition snapshot to the snapshot of raw data for the time.

14. The data modeling system of claim 8, wherein the request specifies a concept associated with the data model definition snapshot and the version of the data model definition only includes data objects associated with that specified concept.

15. A non-transitory computer readable medium, comprising instructions for:
storing raw data received from one or more data sources at a data management system, wherein raw data from the one or more data sources is received according to different data schemas;
determining a requested concept defined in a semantic layer of a data model definition, wherein:
the data model definition includes multiple layers of concepts, and transformations between each of the multiple layers of concepts,
the multiple layers include a first layer comprising a device layer and a second layer comprising the semantic layer,
the transformations define a derivation for generation of data for concepts in a more abstract layer of the multiple layers from concepts in a less abstract layer of the data model definition;
generating a working data model comprising first data objects for the requested concept by:
determining second concepts of the first tier based on the requested concept by evaluating transformations of the data model definition associated with the requested concept, the second concepts associated with data sources providing data associated with the requested concept;
obtaining second data objects associated with the second concepts, the second data objects associated with raw data received from the data sources providing data associated with the requested concept;
adding the second data objects to the working data model;
applying transformations of the data model definition associated with the requested concept to the second data objects associated with raw data received from the data sources to generate the first data objects associated with the requested concept; and
adding the first data objects to the working data model; and
providing the working data model including the requested concept.

16. The non-transitory computer readable medium of claim 15, wherein the working data model is dynamically generated in response to the determination of the requested concept.

17. The non-transitory computer readable medium of claim 15, wherein the second data objects are obtained from a previously materialized data model.

18. The non-transitory computer readable medium of claim 15, wherein the data sources include a Security Posture Management (SPM) system, a Configuration Management Databases (CMDB) system of an Enterprise Resource Planning (ERP) system.

19. The non-transitory computer readable medium of claim 15, wherein the semantic layer includes a foundation layer, an authoritative layer, a reporting semantic layer, a detection layer, or a presentation layer.

20. The non-transitory computer readable medium of claim 15, further comprising instructions for:
storing a data model definition snapshot associated with a time;
storing a data snapshot of raw data associated with the time; and
In response to a request, generating a version of the data model associated with the time by applying the data model definition snapshot to the snapshot of raw data for the time.

21. The non-transitory computer readable medium of claim 15, wherein the request specifies a concept associated with the data model definition snapshot and the version of the data model definition only includes data objects associated with that specified concept.
